(19) United States
(12) Patent Application Publication
(10) Pub. No.: US 2006/0271251 A1
(43) Pub. Date: Nov. 30, 2006

(54) Unmanned vehicle control

(76) Inventor: Jeffrey Alan Hopkins, Fontana, CA (US)

Correspondence Address: HOGAN & HARTSON L.L.P., 1999 AVENUE OF THE STARS, SUITE 1400, LOS ANGELES, CA, 90067, US

(21) Appl. No.: 11/356,626

(22) Filed: Feb. 16, 2006

Related U.S. Application Data
(60) Provisional application No. 60/653,895, filed on Feb. 17, 2005.

(51) Int. Cl. G06F 17/00

(52) U.S. Cl. 701/23; 701/2; 701/24

(57) ABSTRACT

A control system for an unmanned vehicle includes a plurality of servos, a transceiver that receives a plurality of first control signals, and a controller connected to the transceiver and the plurality of servos. The controller receives the first control signals from the transceiver and processes the first control signals to provide a plurality of second control signals to the servos to thereby control the servos and the unmanned vehicle.

### RELATED APPLICATION

This application claims priority to U.S. Provisional Application Ser. No. 60/653,895, filed Feb. 17, 2005, the content of which is incorporated herein by reference in its entirety.

### BACKGROUND OF THE INVENTION

1. Field of the Invention

The present invention relates to control of unmanned vehicles.

2. Description of Related Art

Current control systems for unmanned vehicles, such as remote control (RC) vehicles, utilize radio transmitters that generate analog pulses to actuate servos positioned on the unmanned vehicle. In conventional systems, transmitters utilize a single analog frequency to generate a series of electrical pulses.

Conventional transmitters typically comprise a plurality of toggle sticks or triggers to generate the analog pulses. When actuated, the toggle sticks connect electrical contacts and complete an electrical circuit that allows the transmitter to transmit a series of synchronized electrical pulses. A receiver in the unmanned vehicle monitors the frequency of the transmitter for incoming signals. When the receiver receives signals from the transmitter, the signal is converted into the series of synchronized electrical pulses generated by the transmitter.

The sequence of the electrical pulses is sent to the designated servo to actuate the servo. For example, the sequence of electrical pulse can cause a servo to propel the unmanned vehicle in a forward direction. In another example, a different sequence of electrical pulses can cause the servo to propel the unmanned vehicle in a backward direction.

### SUMMARY OF THE INVENTION

The present invention is directed to a control system for an unmanned vehicle comprising a plurality of servos, a transceiver that receives a plurality of first control signals, and a controller connected to the transceiver and the plurality of servos. The controller receives the first control signals from the transceiver and processes the first control signals to provide a plurality of second control signals to the servos to thereby control the servos and the unmanned vehicle.

In one embodiment, the unmanned vehicle comprises an unmanned aerial vehicle, such as, for example, an airplane or a helicopter. The transceiver comprises a wireless transceiver that transmits and receives the first control signals, and the first control signals comprise wireless signals and digital control data. In one aspect, the transceiver comprises a radio frequency (RF) transceiver that transmits and receives the first control signals, and the first control signals comprise wireless radio frequency (RF) signals, and the wireless radio frequency (RF) signals comprise digital control data.

In one embodiment, the controller comprises a microprocessor, microcontroller, or microcomputer. The controller interprets the first control signals as position control signals for position control of the servos. The controller provides the second control signals as position control signals to control the position of the servos. The control system further comprises at least one power supply that provides power to the transceiver, the plurality of servos, and the controller.

In one embodiment, the control system comprises an onboard control system that is mounted to the unmanned vehicle. The control system further comprises a camera system that is mounted to the unmanned vehicle and transmits video signals. The camera system comprises a digital video camera system that transmits digital video data via wireless signals. In one aspect, the camera system comprises a digital audio and video (AV) camera system that transmits digital audio and video data via wireless signals.

In one embodiment, the control system further comprises a sensor cluster connected to the controller. The sensor cluster comprises at least one positional and navigational sensor including at least one of a speed sensor, an altimeter sensor, a compass sensor, a pitch sensor, a roll sensor, a yaw sensor, a gps sensor, a position sensor, a direction sensor, and a turning direction sensor. The controller transmits sensor data and information related to the at least one positional and navigational sensor via the transceiver.

In one aspect, the present invention is directed to a control system for an unmanned vehicle comprising a plurality of servos, a wireless transceiver that receives digital data via a plurality of wireless signals, and a controller connected to the wireless transceiver and the plurality of servos. The controller receives the digital data from the wireless transceiver, interprets the digital data as servo control data, and generates servo control signals to provide to the servos to thereby control the unmanned vehicle.

In one aspect, the present invention is directed to a control system for an unmanned vehicle having a plurality of servos. In one embodiment, the control system comprises a first controller that generates digital control data and a first transceiver connected to the first controller so as to receive the digital control data from the first controller. The first transceiver transmits a plurality of wireless control signals comprising the digital control data. A second transceiver receives the plurality of wireless control signals from the first transceiver and extracts the digital control data therefrom. A second controller is connected to the second transceiver and the plurality of servos. The second controller receives the digital control data from the second transceiver and interprets the digital control data as servo control data to provide a plurality of servo control signals to the servos to thereby control the servos and the unmanned vehicle.

In one embodiment, the first controller generates the digital control data based, at least in part, on user input commands. The control system further comprises a servo controller connected between the second controller and the plurality of servos. The servo controller receives the digital control data from the second controller and interprets the digital control data as servo control data to provide the plurality of servo control signals to the servos to thereby control the unmanned vehicle. The servo controller interprets the servo control data as servo control signals for position control of the servos.

In one aspect, the present invention is directed to a control system for an unmanned aerial vehicle having a plurality of servos. In one embodiment, the system comprises a base controller that generates digital control data and a base wireless transceiver connected to the base controller so as to receive the digital control data from the base controller. The base wireless transceiver transmits a plurality of wireless control signals comprising the digital control data. An onboard wireless transceiver, positioned on the unmanned aerial vehicle, receives the plurality of wireless control signals from the base wireless transceiver and extracts the digital control data therefrom. A first onboard controller, positioned on the unmanned aerial vehicle, is connected to the onboard wireless transceiver so as to receive the digital control data from the onboard wireless transceiver and process the digital control data to generate digital servo control data. A second onboard controller, positioned on the unmanned aerial vehicle, is connected to the first onboard controller and the plurality of servos. The second onboard controller receives the digital servo control data from the first onboard controller and interprets the digital servo control data as servo position data to provide a plurality of servo control signals to the servos to thereby control the unmanned aerial vehicle.

In one embodiment, the second onboard controller comprises a servo controller that interprets the digital servo control data as servo position data to provide a plurality of servo position signals to the servos for position control of the servos. The control system further comprises an onboard camera system that is mounted to the unmanned aerial vehicle and transmits video signals to the base controller. The onboard camera system comprises a digital video camera system that transmits digital video data to the base controller via wireless signals. In one aspect, the onboard camera system comprises a digital audio and video (AV) camera system that transmits digital audio and video data to the base controller via wireless signals.

In one embodiment, the control system further comprises at least one base power supply that provides power to at least the base controller and the base wireless transceiver. The control system further comprises at least one onboard power supply mounted to the unmanned aerial vehicle that provides power to at least the onboard wireless transceiver, the first onboard controller, the second onboard controller, and the plurality of servos.

In one embodiment, the control system further comprises a sensor cluster connected to the first onboard controller. The sensor cluster comprises at least one positional and navigational sensor including at least one of a speed sensor, an altimeter sensor, a compass sensor, a pitch sensor, a roll sensor, a yaw sensor, a gps sensor, a position sensor, a direction sensor, and a turning direction sensor. The first onboard controller transmits digital data and information related to the at least one positional and navigational sensor to the base controller via wireless signals from the onboard wireless transceiver.

In one aspect, the present invention is directed to a method for controlling an unmanned vehicle having a plurality of servos. In one embodiment, the method comprises receiving wireless signals comprising digital control data, extracting the digital control data from the wireless signals, interpreting the digital control data as servo control data, generating servo control signals from the servo control data, and providing the servo control signals to the servos to thereby control the unmanned vehicle.

In one embodiment, the unmanned vehicle comprises an unmanned aerial vehicle including an airplane or a helicopter.

In one embodiment, the method further comprises generating digital control data and transmitting wireless control signals comprising the digital control data. Receiving wireless signals comprises receiving wireless radio frequency (RF) signals comprising the digital control data. Interpreting the digital control data as servo control data comprises interpreting the digital control data as servo position data for position control of the servos.

In one embodiment, the method further comprises sensing positional and navigational orientation including sensing at least one of speed, altitude, compass direction, pitch, roll, yaw, geographical position, and turning direction. The method further comprises transmitting digital data and information related to sensing positional and navigational orientation via wireless signals.

In one embodiment, the method further comprises transmitting video signals from the unmanned vehicle. Transmitting video signals comprises transmitting digital video data from the unmanned vehicle via wireless signals, and in one aspect, transmitting video signals comprises transmitting digital audio and video (AV) data from the unmanned vehicle via wireless signals.

Other features and advantages of the invention will be apparent from the following detailed description, taken in conjunction with the accompanying drawings which illustrate, by way of example, various features of embodiments of the invention.

### BRIEF DESCRIPTION OF THE DRAWINGS

FIG. 1A is a block diagram of one embodiment of an onboard control system and a first onboard transceiver for an unmanned vehicle.

FIG. 1B is a block diagram of one embodiment of a base control system and a first base transceiver for remote base control of an unmanned vehicle.

FIG. 1C is a block diagram of one embodiment of an onboard control system and a first onboard transceiver and an onboard camera system and a second onboard transceiver for unmanned vehicle.

FIG. 1D is a block diagram of one embodiment of a base control system and a second base transceiver positioned remotely from unmanned vehicle.

FIGS. 2A-2F are block diagrams of various embodiments of onboard control system of FIGS. 1A and 1C.

FIGS. 3A-3B are block diagrams of various embodiments of onboard camera system of FIGS. 1C and 1D.

FIGS. 4A-4C are block diagrams of various embodiments of base control system of FIGS. 1B and 1D.

FIGS. 5A-5D are diagrams of various embodiments of onboard control system and base control system for the unmanned vehicle.

### DETAILED DESCRIPTION OF THE INVENTION

Reference will now be made to the drawings wherein like numerals refer to like parts throughout.

The present invention discloses applications, devices, methods, and systems involving digital control of unmanned vehicles, including unmanned aerial vehicles (UAV), such as, for example, an airplane or a helicopter. However, it should be appreciated by those skilled in the art that the unmanned vehicle may also include an unmanned land or water based vehicle, such as, for example, a ground vehicle including an automobile, a car, truck, semi-truck or bus, a train, including a subway train or light rail train, and a water vehicle, including a boat, ship or sailing vessel.

In one embodiment of the present invention, as will be described in greater detail herein below, the control system of the unmanned vehicle includes an onboard control system and a base control system that is configured to transmit wireless control signals comprising digital control data to the onboard control system of the unmanned vehicle so as to control a plurality of servos positioned on the unmanned vehicle. In one aspect, the servos provide for precise positional movement of armature that is linked or connected to mechanical control devices on the unmanned vehicle, such as, for example, a main rotor, a tail rotor, and throttle of the engine of a helicopter.

The control system of the present invention affords numerous control features and programmable options for the onboard control system of the unmanned vehicle via a base control system, such as a personal computer (PC), a laptop computer, a tablet computer, and a personal digital assistant (PDA), through various communication systems, devices, and ports, such as, for example, an Ethernet, parallel, serial, USB, SCSI, PCI, LAN, wireless LAN, and broadband. In one aspect, the onboard control system of the unmanned vehicle is configured to communicate with the base control system so that wireless control signals are transmittable between these systems.

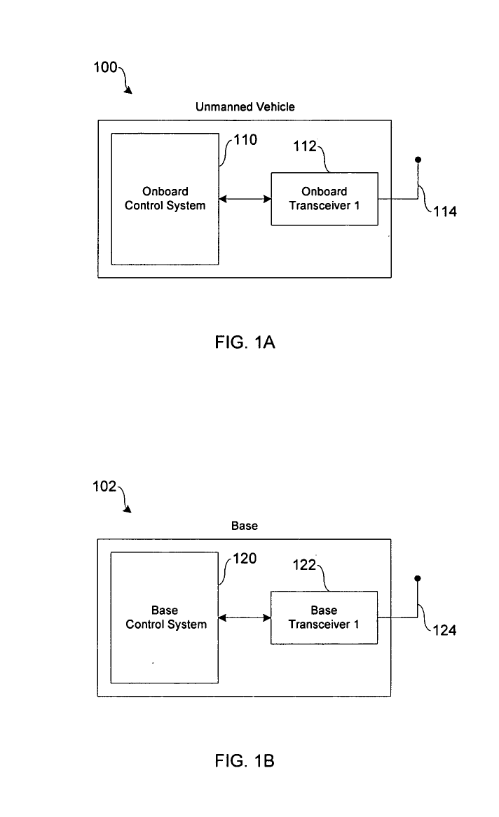

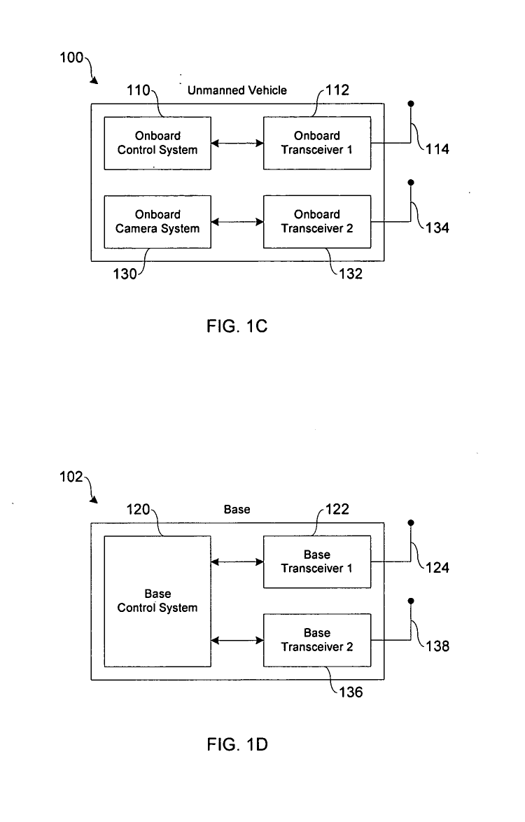

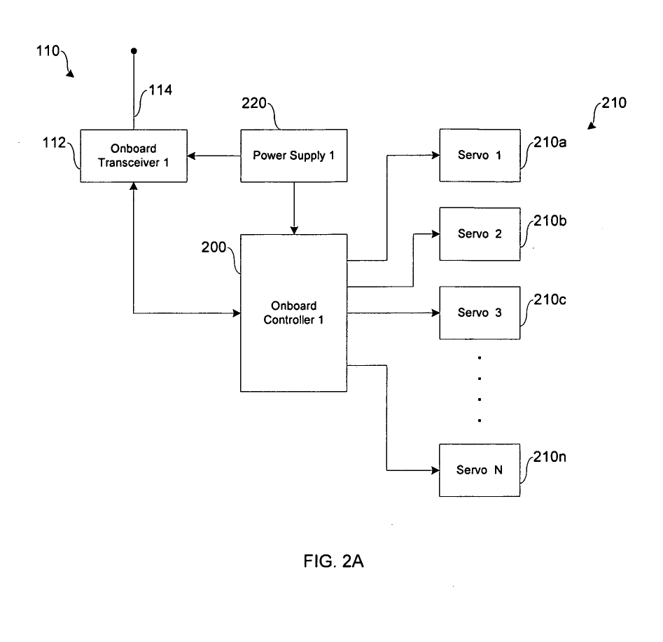

FIG. 1A is a block diagram of one embodiment of an onboard control system 110 and a first onboard transceiver 112 for an unmanned vehicle 100 that are positioned on unmanned vehicle 100. Onboard control system 110 is connected to first onboard transceiver 112 for transfer and reception of data and information to and from first onboard transceiver 112. First onboard transceiver 112 is connected to an antenna 114 for transmission and reception of wireless signals comprising data and information.

In one aspect, onboard control system 110 transfers data and information to first onboard transceiver 112 for wireless transmission of the data and information via wireless signals. First onboard transceiver 112 receives wireless signals comprising data and information for transfer to onboard control system 110. Onboard control system 110 receives data and information from first onboard transceiver 112 after reception of wireless signals comprising data and information. For purposes of digital control of unmanned vehicle 100, the data and information may comprise digital data and information.

In one aspect, digital data and information can be encoded and modulated with a carrier signal to form a transmittable signal that may include a wireless signal. When the encoded and modulated signal is received by a receiver or transceiver, the received signal is demodulated and decoded by the receiver or transceiver to extract or gain access to the transmitted digital data and information.

FIG. 1B is a block diagram of one embodiment of a base control system 120 and a first base transceiver 122 for remote base 102 control of unmanned vehicle 100 that are positioned remotely from unmanned vehicle 100. Base control system 120 is connected to first base transceiver 122 for transfer and reception of data and information to and from first base transceiver 122. First base transceiver 122 is connected to an antenna 124 for transmission and reception of wireless signals comprising data and information.

In one aspect, base control system 120 transfers data and information to first base transceiver 122 for wireless transmission of the data and information via wireless signals. First base transceiver 122 receives wireless signals comprising data and information for transfer to base control system 120. Base control system 120 receives data and information from first base transceiver 122 after reception of wireless signals comprising data and information.

In one embodiment, unmanned vehicle 100 of the present invention is remotely controlled with communication between onboard control system 110 of FIG. 1A positioned on unmanned vehicle 100 and base control system 112 of FIG. 1B positioned remotely from unmanned vehicle 100. Onboard control system 110 includes first onboard transceiver 112 that wirelessly communicates with first base transceiver 122 of base control system 120.

In one embodiment, first and second transceivers 112, 122 comprise wireless transceivers that transmit and receive wireless signals comprising digital data and information. The first and second transceivers 112, 122 may comprise radio frequency (RF) transceivers that transmit and receive wireless radio frequency (RF) signals, and the wireless RF signals comprise digital data and information. First onboard transceiver 112 is positioned on the unmanned vehicle, and first base transceiver 122 comprises a base transceiver positioned remotely from the unmanned vehicle.

In one embodiment, first onboard transceiver 112 and first base transceiver 122 comprise, for example, 9XStream 900 MHz FHSS (Frequency Hopping Spread Spectrum) RF (Radio Frequency) transceivers manufactured by MaxStream, Inc. in Lindon, Utah. The 9XStream RF transceiver module is a wireless serial RF transmission device that transfers a standard asynchronous serial data stream over an air transmission channel between computing devices. The 9XStream RF transceiver module is a high-performance RFd2d (radio frequency device-to-device) serial transceiver.

The 9XStream RF transceiver module is a long range serial data transmission device with an indoor transmission range of up to 1500 feet (450 m), an outdoor line-of-sight transmission range of up to 7 miles (11 km) with use of a 2.1 dBm dipole antenna, and an outdoor line-of-sight transmission range of up to 20 miles (32 km) with a high gain antenna.

The 9XStream RF transceiver module is a portable serial interface device with an onboard CMOS RS232 UART device and software selectable serial interface baud rates between 1200-57600 bps. The 9XStream RF transceiver module provides a continuous RF data stream between communicating transceivers with baud rates of up to 19,200 bps with no configuration required and supports multiple data formats including parity, start bits, and stop bits. In one aspect of the present invention, the serial interface baud rates of the 9XStream RF transceiver modules are configured with a baud rate of 9600 bps. However, the 9XStream RF transceiver modules are configured to communicate with each other at a baud rate of 19,200 bps.

For serial communications, the 9XStream RF transceiver module interfaces to a host device, such as the BS2 microcontroller module, through a CMOS-level asynchronous serial port. In general, the 9XStream RF transceiver module can communicate with any UART voltage compatible device or through a level translator to any RS-232/485/422 device. The UART performs processing tasks, such as timing and parity checking, for serial data communications. In general, serial communication with RS-232 type devices involves at least two UART devices that are configured with compatible parameters, including baud rate, parity, start bits, stop bits, and data bits, to have successful communication. In serial communications, each transmitted data packet includes a start bit (low) and 8 data bits (least significant bit first) followed by a stop bit (high).

The 9XStream RF transceiver module transmits and receives serial data using serial RF data packets. The 9XStream RF transceiver module also utilizes CRC (Cyclic Redundancy Check) to verify data integrity and provide built-in error checking. A 16-bit CRC code is computed for the transmitted data and attached to the end of each serial RF data packet. On the receiving end, the receiving module computes the CRC on all incoming serial RF data, wherein received data that has an invalid CRC is discarded.

In one aspect, any of the transceivers disclosed herein may comprise multi-frequency, multi-band transceivers that are configured to communicate according to standard communication systems, devices, and protocols including various generally known types of serial communication systems, devices, and protocols. For example, various types of serial communication systems, devices, and protocols may include at least one of a wireless local area network (LAN), various Internet systems, devices and protocols, including modems, routers, etc., and various cellular phone systems, devices and protocols, including CDMA, TDMA, etc.

In one embodiment, the onboard control system of FIG. 1A further comprises an onboard camera system that is mounted to the unmanned vehicle and transmits and receives wireless signals comprising video data and information.

FIG. 1C is a block diagram of one embodiment of onboard control system 110 and first onboard transceiver 112 of FIG. 1A and an onboard camera system 130 and a second onboard transceiver 132 for unmanned vehicle 100 that are positioned on unmanned vehicle 100. Onboard camera system 130 is connected to second onboard transceiver 132 for transfer and reception of data and information, including video data and information, to and from second onboard transceiver 132. Second onboard transceiver 132 is connected to an antenna 134 for transmission and reception of wireless signals comprising data and information, including video data and information. It should be appreciated that the onboard camera system 130 may be connected to first onboard transceiver 200 without departing from the scope of the present invention.

In one aspect, onboard camera system 130 transfers data and information, including video data and information, to second onboard transceiver 132 for wireless transmission of the data and information to base control system 120 via wireless signals. Second onboard transceiver 132 can also receive wireless signals comprising data and information from base control system 120 for transfer to onboard camera system 130. Onboard camera system 130 can also receive data and information from second onboard transceiver 132 after reception of wireless signals comprising data and information. This data and information may be utilized to communicate with the onboard camera system 130.

It should be appreciated by those skilled in the art that, in one aspect, onboard camera system 130, including various components thereof, may be a part of onboard control system 110 without departing from the scope of the present invention.

FIG. 1D is a block diagram of one embodiment of base control system 120 and a second base transceiver 136 positioned remotely from unmanned vehicle 100. Base control system 120 is connected to second base transceiver 136 for transfer and reception of data and information, including video data and information, to and from second base transceiver 136. Second base transceiver 136 is connected to an antenna 138 for transmission and reception of wireless signals comprising data and information, including video data and information.

In one aspect, base control system 120 transfers data and information to second base transceiver 136 for wireless transmission of data and information via wireless signals. Second base transceiver 136 receives wireless signals comprising data and information, including video data and information, for transfer to base control system 120. Base control system 120 receives data and information from second base transceiver 136 after reception of wireless signals comprising data and information, including video data and information.

In one embodiment, onboard camera system 130 comprises a digital video camera system that transmits digital video data and information via wireless signals. In another embodiment, onboard camera system 130 comprises a digital audio and video (AV) camera system that transmits digital audio and video data and information via wireless signals.

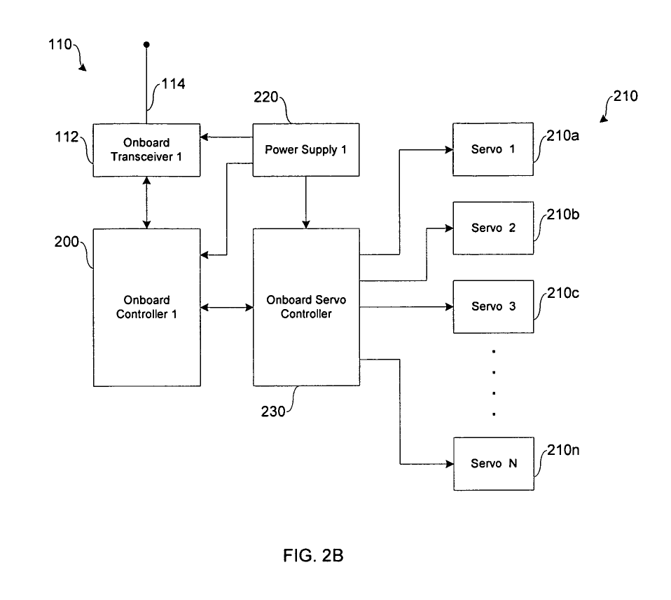

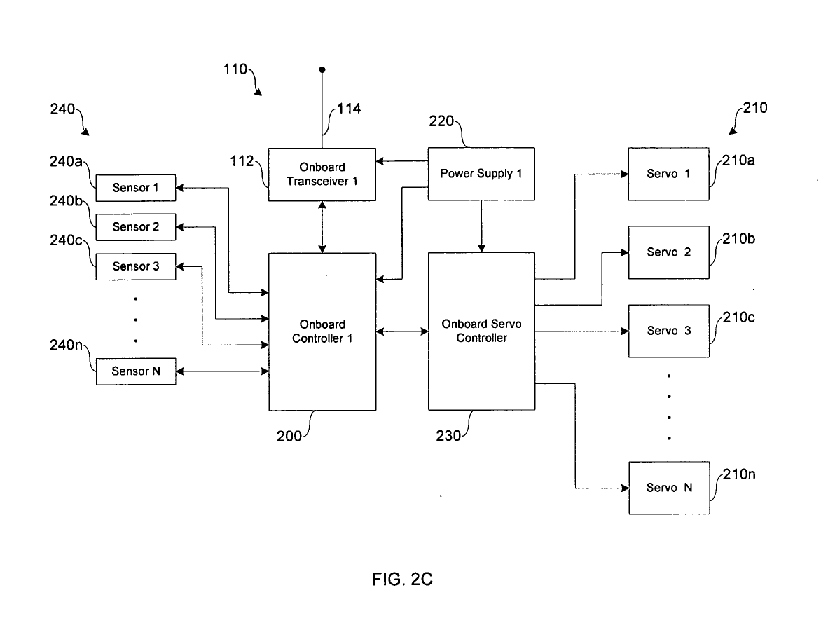

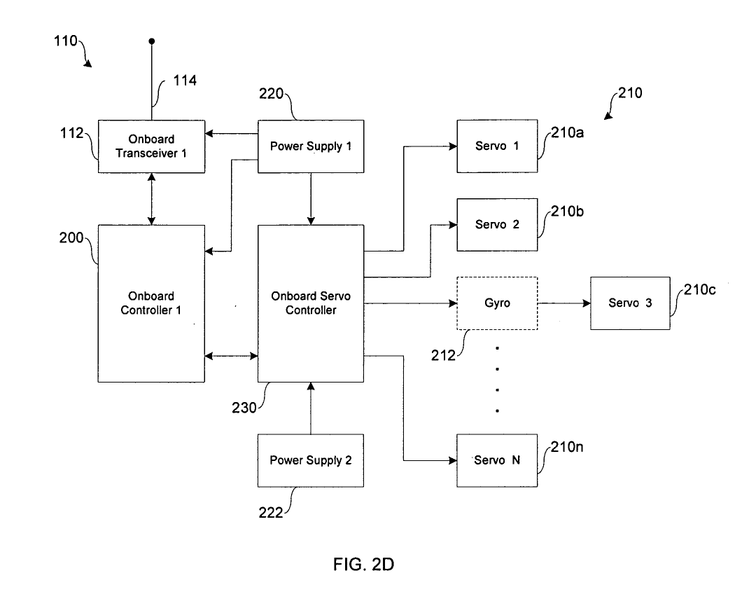

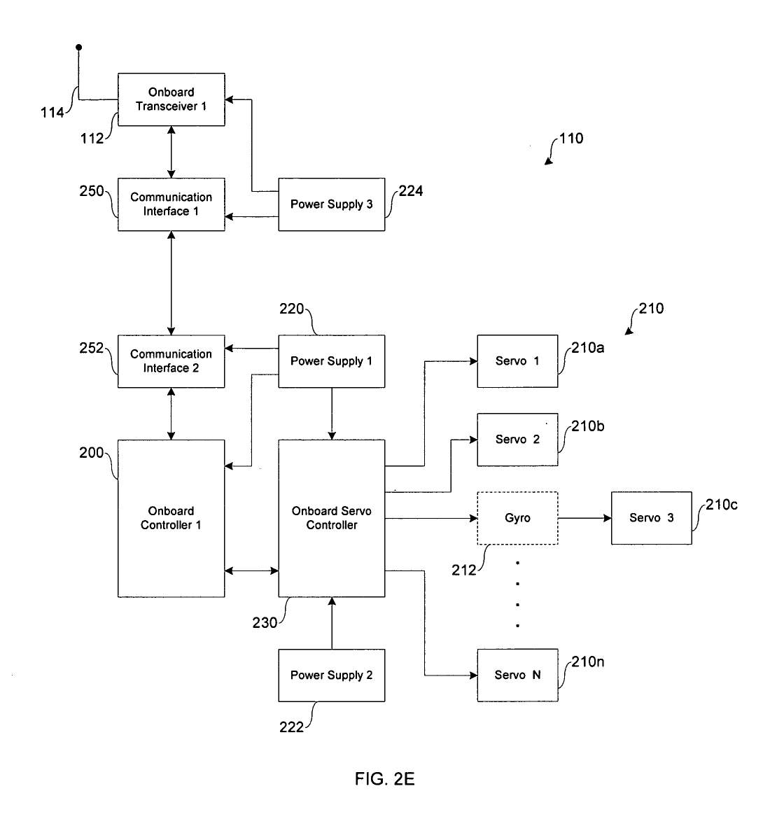

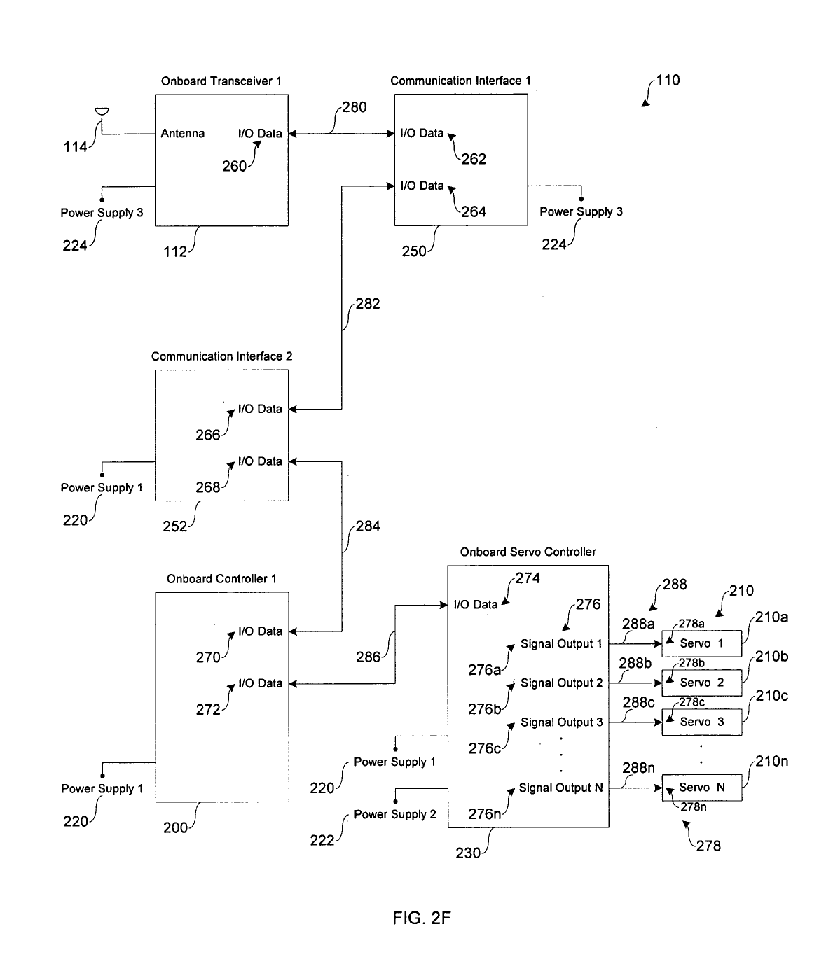

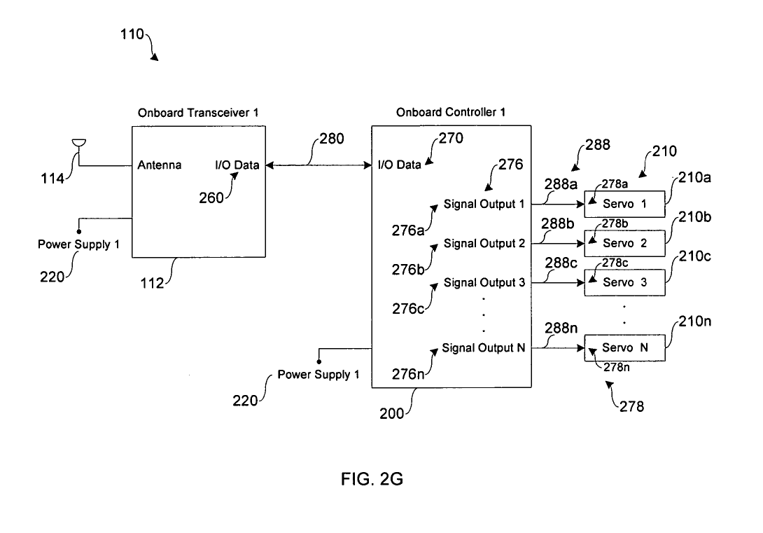

FIGS. 2A-2F are block diagrams of various embodiments of onboard control system 110 of FIGS. 1A and 1C.

As shown in FIG. 2A, onboard control system 110 comprises a first onboard controller 200 and a plurality of servos 210. First onboard controller 200 is connected to first onboard transceiver 112 and servos 210. As previously described, first onboard transceiver 112 is connected to antenna 114 for transmission and reception of wireless signals comprising data and information, including digital data and information, and first onboard transceiver 112 transmits and receives wireless signals comprising data and information, including digital data and information.

In one aspect, the wireless signals comprise wireless control signals, including wireless digital control signals. Therefore, in one example, first onboard transceiver 112 is adapted to receive a plurality of first control signals, including wireless control signals comprising digital data, such as digital control data. First onboard controller 200 receives the first control signals from first onboard transceiver 112 and processes the first control signals to provide a plurality of second control signals to servos 210 to thereby control servos 210 and the unmanned vehicle.

In one embodiment, first onboard controller 200 is positioned on the unmanned vehicle and comprises a microprocessor, microcontroller, or microcomputer that interprets the first control signals as position control signals for position control of servos 210. In one aspect, first onboard controller 200 provides the second control signals as position control signals to control the position of servos 210.

In one embodiment, first onboard controller 200 comprises a Basic Stamp II BS2 microcontroller module manufactured by Parallax, Inc. in Rocklin, Calif. The BS2 controller module includes a PBASIC Interpreter chip, internal memory (RAM and EEPROM), a 5V voltage regulator, 16 general purpose I/O pins (TTL-level, 0-5 volts), two dedicated serial I\O pins (9600 baud), and a set of built-in commands for math and I/O pin operations. The BS2 controller module is capable of running approximately 12 thousand instructions per second and are programmed with a simplified and customized form of the BASIC programming language referred to as PBASIC. In general, PBASIC is a high-level programming language that is highly optimized for embedded control of the BS2 controller module.

In one aspect, an original PBASIC based software program, written and compiled with the Basic Stamp Editor (Version 2.1) provided by Parallax, was utilized to configured the BS2 controller module to receive, translate, interpret, and transmit serial data sent from base controller 400 of land base control system 120.

In one embodiment, the plurality of servos 210 include one or more servos 210a, 210b, 210c, 210n positioned on the unmanned vehicle. The one or more servos 210 provide for precise positional movement of armature that is linked or connected to mechanical control devices of the unmanned vehicle, such as, for example, a main rotor, tail rotor, and throttle of an engine of a helicopter. Servos 210 may include analog and/or digital types of servos.

In one aspect, servos 210 are configured to receive pulse-proportional signals from, for example, first onboard controller 200 that are translated into specific positional and mechanical movements to control the unmanned vehicle. The pulse-proportional signal may comprise pulses ranging from 1 to 2 milliseconds with a frequency, for example, of approximately 60 times a second. Three basic types of servo motors are utilized in modern servo control systems including DC servo motors for DC motor designs, AC servo motors for induction motor designs, and AC brushless servo motors for synchronous motor designs. In the present invention, DC servo motors can be utilized to provide exceptional control capability.

In general, a servo is a small motorized device that includes an output drive shaft that is connectable to mechanical devices. During operation of the servo, the drive shaft is selectively positioned to specific angular positions by sending or transmitting a pulse-coded signal to an input line of the servo. The servo maintains a specific angular position on the drive shaft at least while the pulse-coded signal is maintained on the input line of the servo. The angular position of the drive shaft is selected by altering or changing the width of the pulse-coded signal to the input line of the servo. In the present invention, a plurality of servos 210 are utilized in the unmanned vehicle to robotically control the position of mechanical steering and throttle mechanisms.

Additionally, the servo includes an electric motor in which the drive shaft does not continuously rotate through 360° intervals. The drive shaft of the servo is positioned based on a pulse width modulated (PWM) input signal. The PWM input signal is a positive leading edge pulse having a width between, for example, approximately 0.5 ms and 2.5 ms to rotate the drive shaft between approximately 0° and 180°. The pulse of the PWM input signal is periodically refreshed to maintain a controlled step position.

Moreover, the output drive shaft of the servo is positioned in proportion to the width of a pulse-proportional signal. The servo includes a capability to rotate in a clockwise or counterclockwise direction with up to approximately 180° mechanical range of motion. In some applications, servos may be configured for a 90° range of motion due to a limited range of motion of the mechanical steering mechanisms. However, it should be appreciated that many servos have more than 90° mechanical range of motion to improve control and to allow for adjustment of component variations, mounting position, etc. In the present invention, servos 210 include a defined mechanical range of motion of 180° with 254 step positions having an 8-bit characteristic within the 180° mechanical range of motion. Each 8-bit step position corresponds to a specific pulse width. For example, a step position value of 0 corresponds to a pulse of approximately 0.5 ms, and a step position value of 254 corresponds to a pulse of approximately 2.53 ms. In one aspect, each step position is separated by a change in pulse width of approximately 80 ms, and the positioning resolution is approximately 0.709° per step (180° divided by 254 steps).

In one embodiment, servos 210 comprise, for example, Futaba digital servos having a coreless motor, high-speed accuracy, metal gears, and resistance to the environment, such as dust and water. It should be appreciated that any type of servo can be utilized in the present invention without departing from the scope of the present invention.

In general, digital servos have significant operational advantages over standard analog servos. Digital servos feature high-capacity, high-current wire for low resistance while maintaining standard servo dimensions and light weight for mounting to the helicopter. Digital servos have a reduced response time and typically reach full power almost instantly. Digital servos include a FET amplifier, a heavy duty 50 strand lead, and an integrated microprocessor for processing incoming control signals and controlling the power to the servo motor so as to increase position resolution and provide improved holding power. During operation, the microprocessor of the digital servo applies preset parameters to the incoming control signal before sending pulse signals of power to the servo motor. This increases the length of the pulse power so that the amount of power sent to activate the motor is adjusted by the program stored on the microprocessor to match functional requirements and optimize the performance of the servo. The microprocessor also sends pulses to the servo motor at a substantially higher frequency. For example, the servo motor receives 300 pulses per second for maintaining the step position of the drive shaft of the servo motor. The higher frequency of the power pulse provides the servo motor with more incentive to turn, which is crucial to sustained control of the unmanned vehicle. As a result, the servo motor responds faster to commands and increases or decreases in power for acceleration/deceleration are transmitted to the servo motor more frequently. Digital servos provide higher resolution, more accurate positioning, faster control response with increased acceleration and deceleration, constant torque throughout servo drive shaft travel, improved resolution, and increased holding power.

As shown in FIG. 2A, onboard control system 110 further comprises at least one power supply, including first power supply 220, that provides power to first onboard transceiver 112, first onboard controller 200, and servos 210. First power supply 220 may comprise a generally known voltage regulator that provides regulated voltage and/or power to each of the onboard components 112, 200, 210 depending on the voltage and/or power requirements of these onboard components 112, 200, 210. In one example, first power supply 220 may comprise a battery source, such as a standard battery source or a rechargeable battery source, including NiCad, Lithium-Ion, Alkaline, and various other generally known types of batteries and battery sources.

In one aspect, voltage and/or power may be supplied to servos 210 by first onboard controller 200 or first power supply 220. In one example, first power supply 220 supplies voltage and/or power to first onboard controller 200, and first onboard controller 200 then supplies voltage and/or power to servos 210. Alternately, first power supply 220 supplies voltage and/or power directly to each servo 210.

In one embodiment, the present invention provides for remote control of the unmanned vehicle via wireless signals comprising digital control data. For example, first onboard controller 200 is connected to first onboard transceiver 112 and servos 210. First onboard transceiver 112 receives wireless signals comprising digital data, including digital control data. First onboard transceiver 112 extracts the digital data from the wireless signals and transfers the digital data to first onboard controller 200. First onboard controller 200 receives the extracted digital data from the first onboard transceiver 112, interprets the digital data as servo control data, and generates servo control signals to provide to servos 210 to thereby control servos 210 and the unmanned vehicle.

In one aspect, first onboard transceiver 112 comprises a digital wireless transceiver that transmits and receives digital data, including digital control data, via a plurality of wireless signals. In another aspect, first onboard transceiver 112 comprises a radio frequency (RF) transceiver that transmits and receives digital data, including digital control data, via a plurality of wireless RF signals. In still another aspect, first onboard controller 200 interprets the digital data as servo control data for position control of servos 210.

As shown in FIG. 2B, onboard control system 110 of FIG. 2A may further comprise a servo controller 230 interposed between first onboard controller 200 and the plurality of servos 210. Servo controller 230 receives digital control data from first onboard controller 200 and interprets the digital control data as servo control data to provide servo control signals to servos 210 to thereby control servos 210 and the unmanned vehicle. In one aspect, servo controller 230 is positioned on the unmanned vehicle and comprises a microprocessor, microcontroller, or microcomputer that interprets the servo control data as servo control signals for position control of servos 210.

In one embodiment, first onboard controller 200, comprises, for example, the BS2 controller module, includes I/O pins for standard serial port communication. The I/O pins function as a port for serial communications that is software accessible via the PBASIC programming language. Onboard servo controller 230 comprises, for example, a serial servo controller that can be controlled via serial control signals provided by the BS2 controller module during operation of the unmanned vehicle. During operation of onboard control system 110, predetermined functions or commands are actuated by the BS2 controller module that correspond to control signals sent from base control system 120 via communication between first onboard transceiver 112 and first base transceiver 122. Software is utilized to program the BS2 controller module to interpret control signals received from base control system 120 and relay or transfer these interpreted functions or commands to the serial servo controller for control of the plurality of servos 210 during operation of the unmanned vehicle. Once the control signals are received, the serial servo controller interprets these commands and provides control signals to the plurality of servos 210 so as to control the helicopter according to the user inputted functions or commands transmitted from base control system 120. Therefore, a plurality of user functions or commands are implemented in software on the BS2 controller module to control servos 210 positioned on the unmanned vehicle during operation of the unmanned vehicle.

In one embodiment, onboard servo controller 230 comprises a SSC II (Serial Servo Controller II) microcontroller module manufactured by Scott Edwards Electronics, Inc. in Sierra Vista, Ariz. The SSC II controller module is an electronic module that controls up to 16 pulse-proportional servos 210 according to data instructions received serially at 2400 or 9600 baud. The default configuration of the SSC II controller module is a baud rate of 2400 baud, operating servos 0 through 7 with a range of motion of 90°. Power supply input for the SSC II controller module is 9 VDC and is provided by first power supply 220, which comprises, for example, a 9 VDC battery. Power supply input for servos 210 is between 4.8V to 6 VDC, depending on the required power input rating of each servo 210, and can be provided by an additional power supply, which comprises, for example, a 4.8 VDC NiCAD rechargeable battery. Serial input signals are received by the SSC II controller module at a serial I/O pin with a corresponding ground pin. The SSC II controller module can be configured for 180° range of motion, additional servo addresses for servos 8-15, and a baud rate of 9600 baud. It should be appreciated that any changes to the default configuration take effect the next time the SSC II controller module is powered.

In one aspect, the SSCII controller module may be configured with a 180° range of motion for each servo with a corresponding step value of approximately 0.72° change in position. Servo addresses match the numbers associated with servos 0 through 7. The baud rate of the SSC II controller module can be configured for a baud rate of 9600 baud. The SSC II controller module receives control data sent with 8 data bits, no parity, 1 stop bit and the data should be inverted according to a typical serial transmission from, for example, a standard PC serial port. The SSC II controller module includes servo connectors that accept standard three-conductor servo plugs, such as Futaba-J connector plugs.

In one aspect, the BS2 microcontroller module is programmed to send control signals to the SSC II controller module. The position of each connected servo 210 can be individually altered by sending three bytes of position data from the BS2 microcontroller module to the SSC II controller module at the appropriate serial baud rate of 9600 baud. These bytes are sent as individual byte values in, for example, decimal format. A sync LED on the SSC II controller module lights steadily after power up and stays on until the first complete three-byte instruction is received. Subsequently, thereafter, the sync LED lights after the SSC II controller module receives a serial instruction comprising a valid sync marker and servo address. The sync LED will stay on until a position byte is received and then turns off when the position byte is received by the SSC II controller module. The three-byte instruction sent from the BS2 microcontroller module to the SSC II controller module includes a first byte [sync marker (255)], a second byte [servo # (0-254)], and a third byte [position (0-254)] in decimal. For example, a three-byte instruction that commands servo number 2 to step position 102 comprises [255] [2] [102] in decimal. In another example, to alter or change this position, another three-byte instruction commanding servo number 2 to step position 196 comprises [255] [2] [196] in decimal. Therefore, the position of each servo can be altered or changed by the BS2 microcontroller module by sending the correct three-byte sequence to the SSC II controller module.

Onboard control system 110 of FIG. 2B comprises at least one first power supply 220 that provides power to first onboard transceiver 112, first onboard controller 200, servos 210, and servo controller 230. First power supply 220 may comprise a generally known voltage regulator that provides regulated voltage and/or power to each of the onboard components 112, 200, 210, 230 depending on the voltage and/or power requirements of these onboard components 112, 200, 210, 230.

As shown in FIG. 2C, onboard control system 110 of FIGS. 2A and 2B may further comprise a sensor cluster 240 having one or more positional and navigational sensors 240a, 240b, 240c, 240n. Sensor cluster 240 is connected to first onboard controller 200. Sensor cluster 240 comprises at least one positional and navigational sensor including at least one of a speed sensor, altimeter sensor, compass sensor, pitch sensor, roll sensor, yaw sensor, gps sensor, position sensor, direction sensor, and turning direction sensor. In one aspect, first onboard controller 200 transmits data and information, including digital data and information, related to the at least one of positional and navigational sensors 240a, 240b, 240c, 240n via wireless signals.

In one aspect, voltage and/or power may be supplied to sensors 240 by first onboard controller 200 or first power supply 220. In one example, first power supply 220 supplies voltage and/or power to first onboard controller 200, and first onboard controller 200 then supplies voltage and/or power to sensors 240. Alternately, first power supply 220 supplies voltage and/or power directly to each sensor 240.

In another aspect, voltage and/or power may be supplied to servos 210 by first onboard controller 200, servo controller 230, or first power supply 220. In one example, first power supply 220 supplies voltage and/or power to first onboard controller 200, and first onboard controller 200 then supplies voltage and/or power to servos 210. In an alternate example, first power supply 220 supplies voltage and/or power to servo controller 230, and servo controller 230 then supplies voltage and/or power to servos 210. In another alternate example, first power supply 220 supplies voltage and/or power directly to each servo 210.

As shown in FIG. 2D, onboard control system 110 of FIGS. 2A, 2B, and 2C may comprise a plurality of power supplies including first power supply 220 and a second power supply 222. In one embodiment, first power supply 220 may supply a first voltage and/or power to first onboard transceiver 112, first onboard controller 200, and servo controller 230, and second power supply 222 may supply voltage and/or power to servo controller 230 for servos 210. For example, second power supply 222 supplies voltage and/or power to servo controller 230, and servo controller 230 then supplies voltage and/or power to servos 210. In an alternate example, second power supply 222 supplies voltage and/or power directly to each servo 210. In one example, first and second power supplies 220, 222 may comprise a battery source, such as a standard battery source or a rechargeable battery source, including NiCad, Lithium-Ion, Alkaline, and various other generally known types of batteries and battery sources.

In one aspect, as shown in FIG. 2D, onboard control system 110 may comprise a gyro 212 positioned on the unmanned vehicle and connected between first onboard controller 200 or servo controller 230 and at least one of the servos 210, such as, for example, servo 210c. It should be appreciated that the inclusion of gyro 212 is optional.

In one embodiment, the unmanned vehicle comprises an unmanned ground based vehicle, such as, for example, an automobile. An automobile requires at least two servos 210 for controlling steering and throttle. Servos 210 are motorized electro-mechanical devices that control movement of the unmanned vehicle. The at least two servos 210 utilized in an automobile include a steering servo and a throttle servo. The steering servo controls the left and right turning direction of, for example, the front wheels for right and left turning of the automobile. The throttle servo controls the rotational speed of, for example, the rear wheels for forward and reverse movement of the automobile.

In one embodiment, the unmanned vehicle comprises an unmanned aerial vehicle (UAV), such as, for example, a helicopter. A helicopter requires at least five servos 210 for controlling fore/aft cyclic, right/left cyclic, collective pitch, throttle, and tail rotor. As previously described, servos 210 are motorized electro-mechanical devices that control movement of the unmanned vehicle. The at least five servos 210 utilized in a helicopter include an aileron servo, an elevator servo, a collective pitch servo, a throttle servo, and a rudder (tail rotor) servo. The aileron servo controls the left and right cyclic of the main rotor. The elevator servo controls the fore and aft cyclic of the main rotor. The collective pitch servo controls the pitch of the main rotor blade. The throttle servo controls the rotational speed of the main rotor blades and tail rotor blades. The rudder or tail rotor servo controls the pitch of the tail rotor for yaw control of the helicopter. In one aspect, gyro 212 is connected inline or in series with the rudder or tail rotor servo for stability during flight. In general, gyro 212 is an electronic device that stabilizes the tail rotor for improved control of the helicopter during flight.

In one embodiment, gyro 212 sends pulse control signals to the rudder (tail rotor) servo when the tail of the helicopter moves. When the tail stops moving, the gyro stops sending the pulse control signal to the rudder servo. Alternately, gyro 212 may continue to send control signals to the rudder servo even when the tail of the helicopter stops moving so as to maintain the position of the rudder servo more securely. When the helicopter encounters a crosswind during flight and the force of the crosswind causes the tail of the helicopter to drift, gyro 212 sends a pulse control signal to the rudder servo to stop the drift. At the same time, gyro 212 may calculate the drift angle and selectively outputs a pulse control signal that resists the force of the crosswind. Thus, drift of the tail of the helicopter is constantly regulated by gyro 212 while the force of the crosswind continues to influence the flight path of the helicopter. Thus, gyro 212 may automatically correct, alter, or change in the tail trim of the helicopter by angular offset of the helicopter flight path caused by the force of the crosswind.

FIG. 2E is a block diagram of another embodiment of onboard control system 110 of FIGS. 1A and 1C. As shown in FIG. 2E, onboard control system 110 may further comprise a first communication interface 250 positioned on the unmanned vehicle and connected to first onboard transceiver 112 and a second communication interface 252 positioned on the unmanned vehicle and connected to first onboard controller 200. In one aspect, data and information, including digital data and information, is transferred between transceiver 112 and first onboard controller 200 via first and second communication interfaces 250, 252.

In one aspect, first and second communication interfaces 250, 252 comprise at least one of communication circuits, devices, and ports with various communication functionality, such as, for example, Ethernet communication, parallel communication, serial communication, and USB (universal serial bus) communication, SCSI communication, PCI communication, LAN communication, wireless LAN communication, and broadband communication, for digital communication between transceiver 112 and first onboard controller 200. It should be appreciated by those skilled in the art that transceiver 112 and first onboard controller 200 can communicate directly with each other using various types of communication protocols, such as, for example, serial or parallel communication.

In one embodiment, first onboard controller 200, comprising, for example, the BS2 controller module, is adapted to communicate with first onboard transceiver 112 via first and second communication interfaces 250, 252. In one embodiment, second serial interface 252 comprises a Basic Stamp Super Carrier board manufactured by Parallax, Inc. The Super Carrier board includes sockets for receiving, supporting, and interfacing the BS2 controller module. The Super Carrier board includes an integrated voltage regulator that accepts 6-30 VDC from first power supply 220, such as a 9 VDC battery. The Super Carrier board includes a conventional serial port (DB9 connector) that can be used for run-time serial communication between the BS2 controller module and an external device via a common serial cable.

In one embodiment, first onboard transceiver 112 comprises for example, the 9XStream RF transceiver module that can be serially interfaced with external hardware devices, such as the BS2 controller module, via communication between first and second communication interfaces 250, 252, as shown in FIG. 2E. In one embodiment, first communication interface 250 comprises, for example, a MaxStream serial interface development board that facilitates the connection between the 9XStream RF transceiver module and serial host devices, such as the BS2 microcontroller module. The MaxStream serial interface development board supports RS-232 protocols and converts serial data signals between CMOS and RS-232 levels to improve portability.

The MaxStream serial interface development board includes a conventional serial port that can be connected to the conventional serial port of the second communication interface 252, comprising, for example, the Stamp Super Carrier board via a common serial cable with a null modem cable adapter attached inline with the serial cable. The common serial cable is shielded to provide protection against impinging frequency signals and channel noise. The null modem cable adapter is utilized to connect two Data Communication Equipment (DCE) devices. In one aspect, the MaxStream serial interface development board is powered with third power supply 224, such as a 9 VDC battery, that provides a regulated power supply voltage of 5 VDC to both the 9XStream RF transceiver module and the MaxStream serial interface development board.

In one embodiment, the MaxStream serial interface board includes a serial port (DB9) that can be used for run-time serial communication with the Super Carrier board, having a similar serial port (DB9) and the BS2 controller module via a serial cable. In the present invention, the serial cable is utilized to establish a communication link between the serial port of the MaxStream serial interface board and the BS2 controller module via the serial port (DB9) of the Super Carrier board.

In one example, first onboard transceiver 112 is adapted to receive a plurality of wireless control signals comprising digital data. First onboard transceiver 112 extracts the digital data from the wireless control signals and transfers the digital data to first onboard controller 200 via communication interfaces 250, 252. First onboard controller 200 receives the digital data from first onboard transceiver 112 via communication interfaces 250, 252 and processes the digital data to provide a plurality of servo control data to servo controller 230. Servo controller 230 receives the servo control data from first onboard controller 200 and provides servo control signals to servos 210 to thereby control servos 210 and the unmanned vehicle.

As shown in FIG. 2E, onboard control system 110 may comprise a third power supply 224 along with first and second power supplies 220, 222. In one embodiment, third power supply 224 may supply voltage and/or power to first onboard transceiver 112 and first communication interface 250. First power supply 220 may supply voltage and/or power to first onboard transceiver 112, first onboard controller 200, servo controller 230, and second communication interface 252. As previously described, second power supply 222 may supply voltage and/or power to servo controller 230 for servos 210. It should be appreciated by those skilled in the art that, in one example, third power supply 224 may supply voltage and/or power to first onboard transceiver 112, and first onboard transceiver 112 supplies voltage and/or power to first communication interface 250. In an alternate example, third power supply 224 supplies voltage and/or power directly to first communication interface 250. In another example, first power supply 220 may supply voltage and/or power to first onboard controller 200, and first onboard controller 200 supplies voltage and/or power to second communication interface 252. In another alternate example, first power supply 220 supplies voltage and/or power directly to second communication interface 252. In one example, first, second, and third power supplies 220, 222, 224 may comprise a battery source, such as a standard battery source or a rechargeable battery source, including NiCad, Lithium-Ion, Alkaline, and various other generally known types of batteries and battery sources.

FIG. 2F is a block diagram of another embodiment of onboard control system 110 of FIGS. 1A and 1C, and FIG. 2F is an exemplary embodiment of onboard control system 110 of FIG. 2E.

As shown in FIG. 2F, first onboard transceiver 112 includes antenna 114 for receiving wireless signals comprising digital control data transmitted from base control system 120 of FIG. 1B via first base transceiver 122.

First onboard transceiver 112 extracts the digital control data from the received wireless signals and transfers the digital control data to first communication interface 250 via an input and output data port 260.

First communication interface 250 receives the digital control data from first onboard transceiver 112 via an input and output data port 262 and transfers or relays the digital control data to second communication interface 252 via an input and output data port 264.

Second communication interface 252 receives the digital control data from first communication interface 250 via an input and output data port 266 and transfers or relays the digital control data to first onboard controller 200 via an input and output data port 268.

First onboard controller 200 receives the digital control data from second communication interface 252 via an input and output port 270 and interprets the digital control data as servo control data to transfer to onboard servo controller 230 via an input and output port 272.

Onboard servo controller 230 receives the servo control data from first onboard controller 200 via an input and output data port 274, generates servo control signals from the servo control data, and provides the servo control signals to servos 210 via one or more output signal ports 276 to thereby control servos 210 and the unmanned vehicle.

Servos 210, including servos 210a, 210b, 210c, 210n, receive the servo control signals from onboard servo controller 230 via one or more input signal ports 278 including 278a, 278b, 278c, 278n.

In one embodiment, servos 210, including one or more servos 210a, 210b, 210c, 210n, are connected to onboard servo controller 230 via output signal ports 276, including one or more output ports 276a, 276b, 276c, 276n. The one or more output ports 276 provide for signal transmission to one or more servos 210 for control of servos 210 and the unmanned vehicle.

In one embodiment, input and output data port 260 of first onboard transceiver 112 is connected to input and output data port 262 of first serial interface 250 for transfer of digital data therebetween via data path 280. Input and output data port 264 of first communication interface 250 is connected to input and output data port 266 of second communication interface 252 for transfer of digital data therebetween via data path 282. Input and output data port 268 of second communication interface 252 is connected to input and output data port 270 of first onboard controller 200 for transfer of digital data therebetween via data path 284. Input and output data port 272 of first onboard controller 200 is connected to input and output data port 274 of onboard servo controller 230 for transfer of digital data therebetween via data path 286. The one or more input and output signal ports 276 of onboard servo controller 230 are connected to the one or more input signal ports 278 of servos 210, including servos 210a, 210b, 210c, 210n, for transfer of servo control signals therebetween via one or more signal paths 288, including signal paths 288a, 288b, 288c, 288n.

FIG. 2G is a block diagram of another embodiment of onboard control system 110 of FIGS. 1A and 1C, and FIG. 2G is an exemplary embodiment of onboard control system 110 of FIG. 2A.

As shown in FIG. 2G, first onboard transceiver 112 includes antenna 114 for receiving wireless signals comprising digital control data transmitted from base control system 120 of FIG. 1B via first base transceiver 122.

First onboard transceiver 112 extracts the digital control data from the received wireless signals and transfers the digital control data to onboard controller via input and output data port 260.

First onboard controller 200 receives the digital control data from first onboard transceiver 112 via input and output port 270, interprets the digital control data as servo control data, generates servo control signals from the servo control data, and provides the servo control signals to servos 210 via one or more output signal ports 276 to thereby control servos 210 and the unmanned vehicle.

Servos 210, including servos 210a, 210b, 210c, 210n, receive the servo control signals from first onboard controller 200 via one or more input signal ports 278 including 278a, 278b, 278c, 278n.

In one embodiment, servos 210, including one or more servos 210a, 210b, 210c, 210n, are connected to first onboard controller 200 via output signal ports 276, including one or more output ports 276a, 276b, 276c, 276n. The one or more output ports 276 provide for signal transmission to one or more servos 210 for control of servos 210 and the unmanned vehicle.

In one embodiment, input and output data port 260 of first onboard transceiver 112 is connected to input and output data port 270 of first onboard controller 200 for transfer of digital data therebetween via data path 280. The one or more input and output signal ports 276 of first onboard controller 200 are connected to the one or more input signal ports 278 of servos 210, including servos 210a, 210b, 210c, 210n, for transfer of servo control signals therebetween via one or more signal paths 288, including signal paths 288a, 288b, 288c, 288n.

It should be appreciated by those skilled in the art that the configuration of onboard control system 110 of the present invention may vary according to the various embodiments described herein without departing from the scope of the present invention.

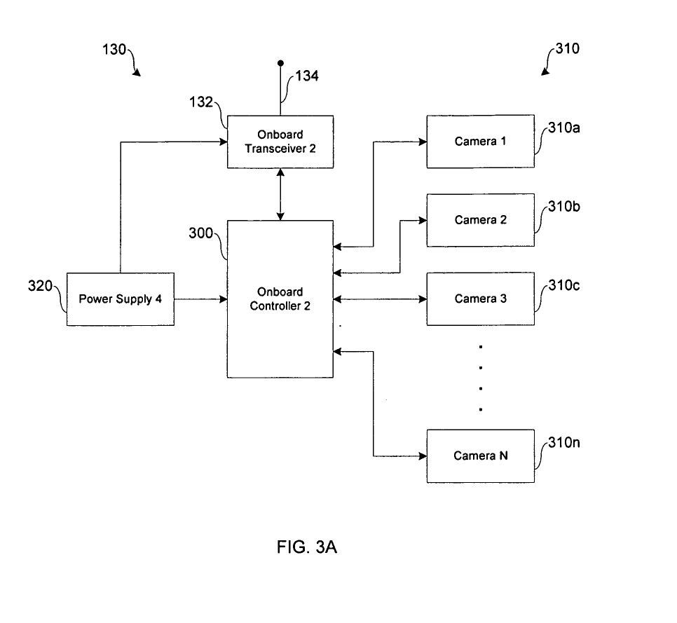

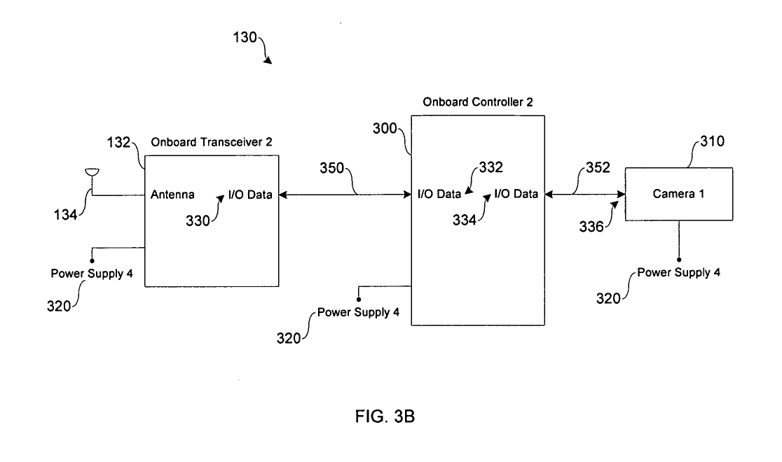

FIGS. 3A-3B are block diagrams of various embodiments of onboard camera system 130 of FIGS. 1C and 1D.

FIG. 3A is a block diagram of one embodiment of onboard camera system 130 and second onboard transceiver 132 of FIGS. 1C and 1D for the unmanned vehicle that are positioned on the unmanned vehicle. Onboard camera system 130 is connected to second onboard transceiver 132 for transfer and reception of data and information, including video data and information, to and from second onboard transceiver 132. Second onboard transceiver 132 is connected to antenna 134 for transmission and reception of wireless signals comprising data and information, including video data and information.

In one aspect, onboard camera system 130 transfers data and information, including video data and information, to second onboard transceiver 132 for wireless transmission of the data and information via wireless signals. Second onboard transceiver 132 receives wireless signals comprising data and information, including video data and information, for transfer to onboard camera system 130. Onboard camera system 130 receives data and information, including video data and information, from second onboard transceiver 132 after reception of wireless signals comprising data and information, including video data and information.

In one embodiment, onboard camera system 130 includes a second onboard controller 300 and one or more cameras 310. Second onboard controller 300 is positioned on the unmanned vehicle and comprises a microprocessor, microcontroller, or microcomputer that receives data and information, including video data and information, from cameras 310. Second onboard controller 300 receives data and information, including video data and information, from cameras 310 and transfers the receives data and information to second onboard transceiver 132 for transmission to base control system 120 via second base transceiver 136. In one aspect, video data and information includes digital video data and information.

In one embodiment, the one or more cameras 310 include one or more cameras 310a, 310b, 310c, 310n positioned on the unmanned vehicle. The one or more cameras 310 capture images, including video images, and provide these images, including video images, to second onboard controller 300 for transfer to base control system 120 via second onboard transceiver 132 and second base transceiver 136. In one aspect, cameras 310 may include analog and/or digital types of cameras.

As shown in FIG. 3A, onboard camera system 130 further comprises at least one power supply, including fourth power supply 320, that provides power to second onboard transceiver 132, second onboard controller 300, and cameras 310. Fourth power supply 320 may comprise a generally known voltage regulator that provides regulated voltage and/or power to each of the onboard components 132, 300, 320 depending on the voltage and/or power requirements of these onboard components 132, 300, 320. In one example, fourth power supply 320 may comprise a battery source, such as a standard battery source or a rechargeable battery source, including NiCad, Lithium-Ion, Alkaline, and various other generally known types of batteries and battery sources.

In one aspect, voltage and/or power may be supplied to cameras 310 by second onboard controller 300 or fourth power supply 320 or first power supply 220. In one example, fourth power supply 320 supplies voltage and/or power to second onboard controller 300, and second onboard controller 300 then supplies voltage and/or power to cameras 310. Alternately, fourth power supply 320 supplies voltage and/or power directly to each camera 310.

In one embodiment, the present invention provides for remote capture of images, including video images and digital video images, from the unmanned vehicle via wireless signals comprising analog and/or digital video data. For example, second onboard controller 300 is connected to second wireless transceiver 132 and one or more cameras 310. Second onboard controller 300 receives analog and/or digital video images from the one or more cameras 310, interprets the analog and/or digital video images as analog and/or digital video data and information, and transfers the analog and/or digital video data and information to second wireless transceiver 132 for transmission to base control system 120. Second wireless transceiver 132 generates and transmits wireless signals comprising the analog and/or digital video data and information to second base transceiver 136. Second base transceiver 136 extracts the analog and/or digital video data and information from the wireless signals and transfers the analog and/or digital video data and information to base control system 120 for viewing thereof on a monitoring device, such as a video monitor or image monitor.

In one aspect, second onboard transceiver 132 comprises a wireless transceiver, including a digital wireless transceiver, that transmits and receives video data and information, including analog and/or digital video data and information, via a plurality of wireless signals. In another aspect, second onboard transceiver 132 comprises a radio frequency (RF) transceiver that transmits and receives video data and information, including analog and/or digital video data and information, via a plurality of wireless RF signals.

In one embodiment, onboard camera system 130 comprises a 2.4 GHz Wireless-G Internet Video Camera manufactured by Linksys, which is a division of Cisco Systems, Inc., in Irvine, Calif. In addition, second onboard controller 300 comprises an internal web server that is integrated into the Linksys Wireless-G Internet Video Camera. During operation of onboard camera system 130, the Linksys Wireless-G Internet Video Camera transmits live video with sound through an Internet based network connection to a web browser on base control system 120. The Linksys Wireless-G Internet Video Camera is a compact and self-contained device that comprises the integrated web server so that the Linksys Wireless-G Internet Video Camera can connect directly to a network, either over Wireless-G (IEEE 802.11 G) networking or over a 10/100 Ethernet cable. The Linksys Wireless-G Internet Video Camera utilizes MPEG-4 video compression to provide high-quality and high-frame-rate digital color video images of up to a 640 by 480 audio/video stream.

Features and specifications of the Linksys Wireless-G Internet Video Camera include compatibility with IEE 802.11 standards including IEEE 802.11 B, IEEE 802.11 G, IEEE 802.3, and IEEE 802.3 U and protocols TCP/IP, HTTP, DHCP, NTP, SMTP, UPnP during discovery only.

The image sensor, such as camera 310, for the Linksys Wireless-G Internet Video Camera comprises a CMOS (Complementary Metal Oxide Semiconductor) color image sensor having VGA compatibility. In general, CMOS image sensors convert light into electrons at photosites that are arranged in a 2-D array of thousands or millions of tiny solar cells, wherein each photosite transforms the light from one small portion of the image into an electron equivalent. These CMOS sensors perform this task using a variety of technologies including having several transistors at each pixel that amplify and move the electron charge. The Linksys Wireless-G Internet Video Camera provides digital color video images at an acceptable data rate due to the high transfer rate of the IEEE 802.11 G protocol.

FIG. 3B is a block diagram of another embodiment of onboard camera system 130 of FIGS. 1C and 1D, and FIG. 3B is an exemplary embodiment of onboard camera system 130 of FIG. 3A. As shown in FIG. 3B, onboard camera system 130 includes second onboard controller 300 connected to at least one camera 310 and second transceiver 132.

In one embodiment, camera 310 captures video data and information, including, for example, digital video data and information. The captured video data and information is transferred from camera 310 to second onboard controller 300 via input and output data port 336.

Second onboard controller 300 receives video data and information, including digital video data and information, from camera 310 via input and output data port 334 and transfers the received video data and information to second onboard transceiver 132 via input and output data port 332 for transmission to base control system 120 via second base transceiver 136.

Second onboard transceiver 132 receives video data and information, including digital video data and information, from second onboard controller 300 via input and output data port 330 and transmits wireless signals comprising the video data and information to base control system 120 of FIG. 1D via second base transceiver 136.

In one embodiment, input and output data port 330 of second onboard transceiver 132 is connected to input and output data port 332 of second onboard controller 300 for transfer of digital data and information therebetween via data path 350. Input and output data port 334 of second onboard controller 300 is connected to input and output port 336 of camera 310 for transfer of digital data and information therebetween via data path 352.

As shown in FIG. 3B, onboard camera system 130 further comprises at least one power supply, such as fourth power supply 320, that provides power to second onboard transceiver 132, second onboard controller 300, and camera 310. In one aspect, voltage and/or power may be supplied to camera 310 by second onboard controller 300 or fourth power supply 320 or first power supply 220. In one example, fourth power supply 320 supplies voltage and/or power to second onboard controller 300, and second onboard controller 300 then supplies voltage and/or power to cameras 310. Alternately, fourth power supply 320 supplies voltage and/or power directly to camera 310.

It should be appreciated by those skilled in the art that the configuration of onboard camera system 130 of the present invention may vary according to the various embodiments described herein without departing from the scope of the present invention.

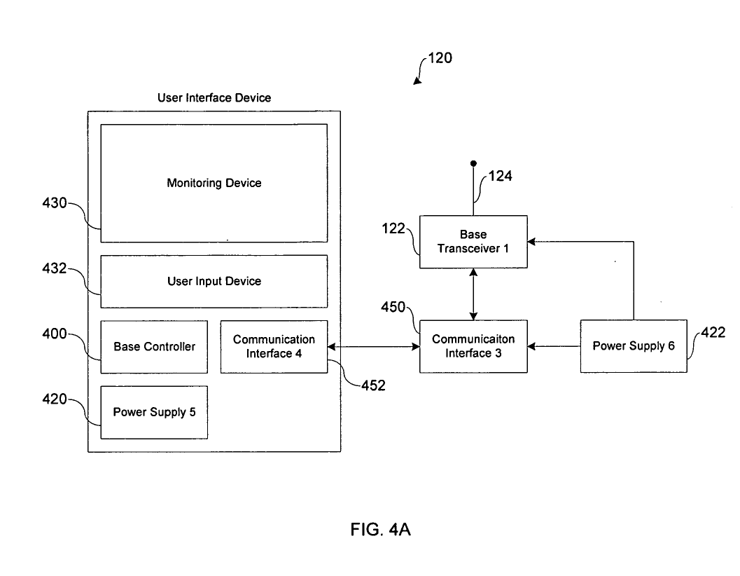

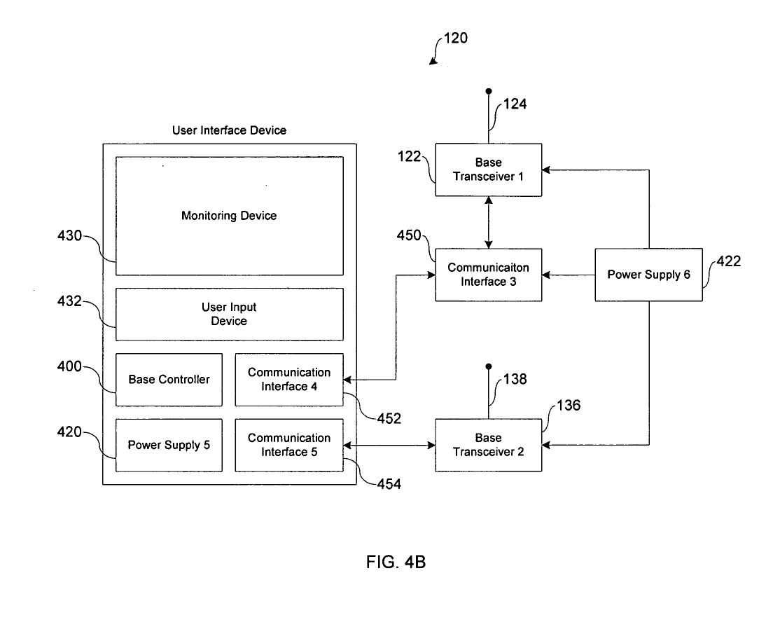

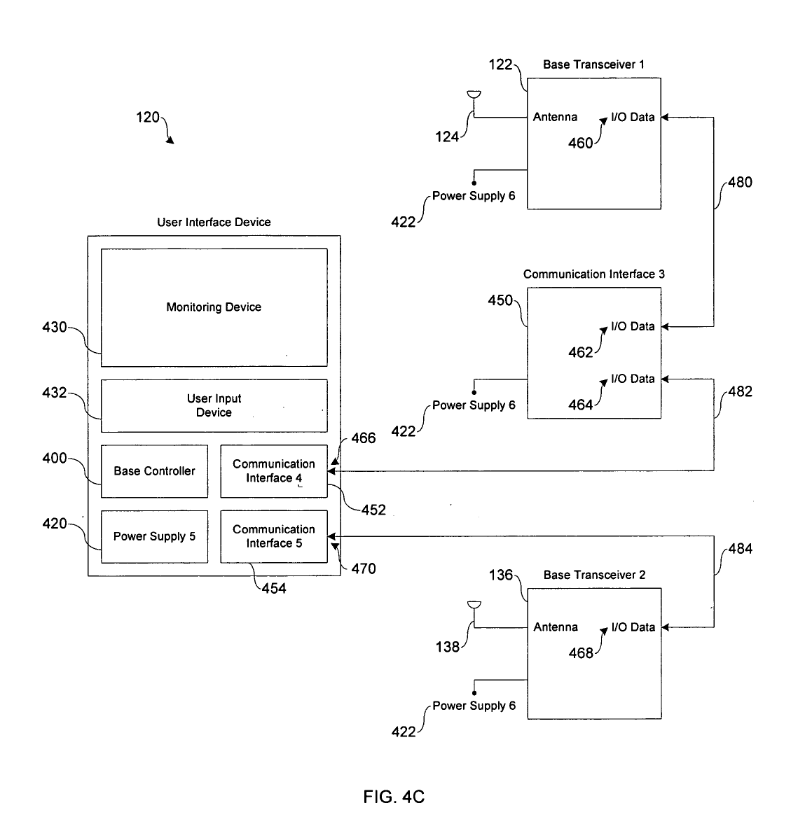

FIGS. 4A-4C are block diagrams of various embodiments of base control system 120 of FIGS. 1B and 1D.

FIG. 4A is a block diagram of one embodiment of base control system 120 and first base transceiver 122 of FIG. 1B for the unmanned vehicle that are positioned remotely from the unmanned vehicle.

In one embodiment, base control system 120 comprises a user interface device or system, such as a computer based system including, for example, a laptop computer, a personal computer (PC), a tablet computer, a personal digital assistant (PDA), or various other small, portable computing devices, having a base controller 400, a power supply 420, a monitoring device 430, a user input device 432, and at least one communication interface 452. It should be appreciated by those skilled in the art that the user interface device may or may not include or require a monitoring device without departing form the scope of the present invention.

Base control system 120, including base controller 400, is connected to first base transceiver 122 via third and fourth communication interfaces 450 and 452. In one aspect, base controller 400 provides and transfers the first control signals to first base transceiver 122 for transmission to the unmanned vehicle including first onboard controller 200 via first onboard transceiver 112. As previously described, first base transceiver 122 is connected to antenna 124 for transmission and reception of wireless signals comprising data and information, including digital data and information, and first base transceiver 122 transmits and receives wireless signals comprising data and information, including digital data and information. In addition, the wireless signals may comprise wireless control signals, including wireless digital control signals.

In one example, first base transceiver 122 is adapted to transmit the first control signals, including wireless control signals comprising digital data, such as digital control data, to the first onboard transceiver 112 positioned on the unmanned vehicle.

In another example, first onboard transceiver 112 is adapted to transmit data and information, including digital data and information, related to at least one of the positional and navigational sensors 240a, 240b, 240c, 240n via wireless signals to the first base transceiver 122. As previously described, first onboard controller is connected to first onboard transceiver 112 and sensor cluster 240. Sensor cluster 240 includes at least one positional and navigational sensor, such as, for example, a speed sensor, altimeter sensor, compass sensor, pitch sensor, roll sensor, yaw sensor, gps sensor, position sensor, direction sensor, and turning direction sensor. In one aspect, first onboard controller 200 transmits data and information, including digital data and information, related to the at least one of positional and navigational sensors 240 to base controller 400 via wireless communication between first onboard transceiver 112 and first base transceiver 122.

In one embodiment, base controller 400 is positioned remotely from the unmanned vehicle and comprises a microprocessor, microcontroller, or microcomputer that generates the first control signals as position control signals for position control of servos 210 on the unmanned vehicle. In one aspect, base controller 400 provides the first control signals to first onboard controller 200 so that first onboard controller 200 can provide the second control signals as, for example, position control signals to servos 210 for position control of servos 210 and control of the unmanned vehicle.

In one embodiment, third communication interface device 450 comprises, for example, at least one of an Ethernet communication device, parallel communication device, serial communication device, USB communication device, etc., for transfer or relay of data and information, including digital data and information from first base transceiver 122 to base control system 120, including base controller 400.

In one embodiment, fourth communication interface device 452 is connected and adapted to communicate with base controller 400 and first base transceiver 124 via third communication interface 450 and comprises, for example, at least one of an Ethernet port, parallel port, serial port, USB port, etc.

In one aspect, base control system 120, including base controller 400, transfers data and information, including digital data and information, to and from first base transceiver 122 via communication between third and fourth communication interfaces 452, 452. Moreover, base control system 120, including base controller 400, is configured to communicate with onboard control system 110 of FIGS. 1A and 1C via first base transceiver 122 and first onboard transceiver 112 so that wireless control signals comprising, for example, digital data and information, are transmittable between these systems 110, 120.

Base control system 120 further comprises monitoring device 430 that provides a user visual interaction with base control system 120, including base system components 400, 430, 432, 452, and onboard control system 110, including onboard system components 200, 210, 230, 240, positioned on the unmanned vehicle. Monitoring device 430 is connected to base controller 400 so that data and information relating to control of servos 210 and the unmanned vehicle can be monitored and/or viewed by a user. In one embodiment, monitoring device 430 comprises a generally known video and image monitor, such as, for example, a liquid crystal display (LCD) type of monitor, a cathode ray tube (CRT) type of monitor, and various other types of generally known video and image monitors.

Base control system 120 further comprises user input device 432, such as a keyboard, for user input of data and information, including user control data and information. User input device 432 is connected to base controller 400 so that user input, such as a keystroke on a keyboard device, is transferred and received by base controller 400. Base controller 400 includes memory for storage of a control program that is executable by base controller 400 for control of the unmanned vehicle. The user input via the user input device 432 is received and interpreted by base controller 400 as a command to control servos 210, including the position of the servos, on the unmanned vehicle for control of the unmanned vehicle. In one embodiment, besides a keyboard input device, user input device 432 may also comprise a numeric keypad, joystick, game pad, mouse, scroll, voice command input device, biometric input device, and/or various other generally known user input devices without departing from the scope of the present invention.

For example, one or more joystick controllers may be interfaced to base control system 120 for control of servos 210 of onboard control system 110 of the unmanned vehicle. The one more joysticks would provide a user with a different method of control of servos 210 and the unmanned vehicle instead of keyboard input on base control system 120, such as, for example, a laptop computer. In one aspect, the one or more joysticks would be configured to simulate real world control by a pilot or driver during operation. In one embodiment for an unmanned aerial vehicle, such as a helicopter, a first joystick may be utilized to mimic the control stick of the helicopter for control of cyclic maneuvers. A second joystick maybe utilized to mimic the two-direction throttle stick of the helicopter for control of the throttle speed. In addition, the second joystick would include a twist grip on the throttle stick that would mimic collective pitch control of the helicopter. A third joystick would be in the form of foot pedals that would mimic the rudder or tail rotor control of the helicopter, wherein a right foot pedal would induce the helicopter to axially rotate in a direction to the right, and a left pedal would induce the helicopter to axially rotate in a direction to the left.

Base control system 120 further comprises at least one power supply, including, for example, fifth power supply 420, that provides power to base control system 120 including base controller 400, monitoring device 430, user input device 432 and fourth communication interface 452. Fifth power supply 420 may comprise a generally known voltage regulator that provides regulated voltage and/or power to each of the control system components 400, 430, 432, 452 depending on the voltage and/or power requirements of these base control system components 400, 430, 432, 452. In one example, fifth power supply 420 may comprise a battery source, such as a standard battery source or a rechargeable battery source, including NiCad, Lithium-Ion, Alkaline, and various other generally known types of batteries and battery sources.

In one embodiment, base control system 120 may further comprise another power supply, including, for example, sixth power supply 422, that provides power to first base transceiver 122 and third communication interface 450. Sixth power supply 422 may comprise a generally known voltage regulator that provides regulated voltage and/or power to each of the control system components 122, 450 depending on the voltage and/or power requirements of these components 122, 450. In one example, sixth power supply 422 may comprise a battery source, such as a standard battery source or a rechargeable battery source, including NiCad, Lithium-Ion, Alkaline, and various other generally known types of batteries and battery sources.

In one aspect, voltage and/or power may be supplied to first base transceiver 122 and third communication interface 450 by base control system 120 or fifth power supply 420. In one example, fifth power supply 420 supplies voltage and/or power to base control system 120, and base control system 120 then supplies voltage and/or power to first base transceiver 122 and third communication interface 450. Alternately, fifth power supply 420 supplies voltage and/or power directly to first base transceiver 122 and third communication interface 450.

In one embodiment, the present invention provides for remote control of the unmanned vehicle via wireless signals comprising digital control data. For example, base controller 400 generates digital control data. First base transceiver 122 is connected to first base controller 400 and receives the digital control data from first base controller 400. First base transceiver 122 transmits a plurality of wireless control signals comprising the digital control data to the unmanned vehicle. First onboard transceiver 112 receives the plurality of wireless control signals from first base transceiver 122 and extracts the digital control data therefrom. First onboard controller 200 is connected to first onboard transceiver 112 and the plurality of servos 210. First onboard controller 200 receives the digital control data from first onboard transceiver 112 and interprets the digital control data as servo control data to provide a plurality of servo control signals to servos 210 to thereby control servos 210 and the unmanned vehicle.

In one aspect, first base transceiver 122 comprises a digital wireless transceiver that transmits and receives digital data, including digital control data, via a plurality of wireless signals. In another aspect, first base transceiver 122 comprises a radio frequency (RF) transceiver that transmits and receives digital data, including digital control data, via a plurality of wireless RF signals. In still another aspect, base controller 400 generates the digital control data based, at least in part, on user input commands from user input device 432. For control of the unmanned vehicle, a user can input a predetermined keystroke to user input device 432, such as, for example, a keyboard device, and base controller 400 receives and interprets the user keystroke as a command to control the unmanned vehicle.

In one embodiment, base control system 120 comprises, for example, a laptop computer that includes a serial port for serial communications. The serial port is software accessible via the C programming language. In one aspect, first onboard controller 200 of the onboard control system 110 of the unmanned vehicle can be accessed via commands inputted by a user with user input device, such as, for example, a keyboard device, that seeks to control servos 210 and the unmanned vehicle. During operation of the base control system 120, predetermined keys on the keyboard of the laptop computer are depressed by a user so as to send corresponding control signals to first onboard controller 200 of onboard control system 110 of the unmanned vehicle. Software is utilized to program the laptop computer to interpret predetermined key functions or commands and relay these interpreted functions or commands to the serial port for transmission to first onboard controller 200 via communication between first base transceiver 122 and first onboard transceiver 112. Once the control signals are received, first onboard controller interprets these commands and provides control signals to onboard servo controller 230 so as to control servos 210 according to user input commands entered by a user via the keyboard device of the laptop computer. Therefore, a plurality of commands are implemented in software on the laptop computer to control servos 210 of the unmanned vehicle during operation via wireless communication.

In one embodiment, first base transceiver 122 and third communication interface 450 include a 9XStream RF transceiver module and a MaxStream serial interface development board, respectively. It should be appreciated that first base transceiver 122 and third communication interface 450 of base control system 120 function similar to first onboard transceiver 112 and first communication interface 250 of onboard control system 110 of the unmanned vehicle. This similar functionality of these devices provides compatibility between the devices so as to provide reliable serial communication between the base control system 120 and onboard control system 110 of the unmanned vehicle. In one aspect, first base transceiver 122 and third communication interface 450 can be powered by sixth power supply 422, such as a 9 VDC battery, that provides a regulated power supply voltage of 5 VDC to both the 9XStream RF transceiver module and the MaxStream serial interface development board.

In one embodiment, during operation, base control system 120, comprising, for example, the laptop computer, serially communicates with the 9XStream RF transceiver module (first base transceiver 122) via the serial communication with the MaxStream serial interface development board (third communication interface 450). The 9XStream RF transceiver module (first base transceiver 122) of the base computer system 120 serially communicates with the 9XStream RF transceiver module (first onboard transceiver 112) of onboard control system 110 of the unmanned vehicle via a wireless serial communication link between the 9XStream RF transceiver modules (first onboard transceiver 112 and first base transceiver 122). The 9XStream RF transceiver module (first onboard transceiver 112) serially communicates with first onboard controller 200, comprising, for example, the BS2 controller module via a serial communication link between the MaxStream serial interface development board (first communication interface 250) and the Super Carrier board (second communication interface 252). Therefore, the laptop computer serially communicates with the BS2 controller module via a wireless communication link established between the 9XStream RF transceiver modules (first base transceiver 122 and first onboard transceiver 112).

In general, serial communication is transfer protocol that allows the serial transfer of digital data and information between computing devices via serial ports, which comprise, for example DB9 serial connectors to connect serial communication devices together. Many computer operating systems, such as a laptop computer, support serial port communication. Even though serial communication ports are currently being replaced with the universal serial bus (USB) communication ports, the serial communication port provides a flexible and powerful means to interface a computer with eternal peripheral devices, such as the unmanned vehicle control system of the present invention.

In general, the term “serial” evolved from the concept of “serializing” data and information prior to transmitting or sending the data. For example, “serializing” data may comprise transmitting each bit of a byte one at a time. A serial communication port requires only one input or output wire connection to transmit 8 individual bits. Before each byte of data is serially transmitted, a serial communication port sends a start bit comprising a single bit with a value of 0. After each byte of data is serially transmitted, the serial communications port sends a stop bit to signal that transmission of the byte is completed. Also, a serial communication port may also send a parity bit. In some computing systems, serial communication ports are also referred to as COM ports, which are bi-directional communication ports that allow each communication device to receive data and transmit serial data. These serial communication ports utilize two different I/O pins to receive and transmit serial data, which provides for full-duplex communication to thereby provide the simultaneous transfer of data in the receive and transmit directions.

Moreover, serial communication ports rely on a special controller referred to as the UART controller (Universal Asynchronous Receiver and Transmitter). The UART controller receives a parallel output of the computer system bus and transforms the received parallel data into serial form for transmission through the serial communication port. For improved performance, most UART controllers include integrated input and output buffers of between 16 and 64 kilobytes. These buffers provide the UART controller to cache data received from the system bus while processing data to and from the serial communication port. The baud rate of serial communication ports is programmable with many standard serial communication ports having transfer rates up to approximately 115 Kbps (kilobits per second).

In one aspect of the present teachings, communication between the laptop computer (base control system 120) and the 9XStream RF transceiver module (first base transceiver 122) occurs at baud rate of approximately 9600 bps, communication between the 9XStream RF transceiver modules (first base transceiver 122 and first onboard transceiver 112) occurs at a baud rate of approximately 19600 bps, and communication between the 9XStream RF transceiver module (first onboard transceiver 112) and the BS2 controller module (firs onboard controller 200) via the Super Carrier board occurs at a baud rate of approximately 9600 bps.

In another aspect of the present teachings, the control signal comprises a single word (two bytes) of data for each command actuated by the user input device, such as, for example, a keyboard device. Due to the small size of the data, the serial transfer of a control signal occurs quickly even at the 9600 bps baud rate. For example, a control signal of a word size (16 bits) transfers between devices in approximately 1.667 milliseconds, which is quick enough to not notice any lag time between the depression of a key on the keyboard of the laptop computer and the actuation of at least one of servos 210 on the unmanned vehicle during operation.

FIG. 4B is a block diagram of one embodiment of base control system 120 and second base transceiver 136 of FIG. 1D for the unmanned vehicle that are positioned remotely from the unmanned vehicle.

Base control system 120, including base controller 400 is connected to second base transceiver 136 for transfer and reception of data and information, including video data and information, to and from second onboard transceiver 132 positioned on the unmanned vehicle. Second base transceiver 136 is connected to antenna 138 for transmission and reception of wireless signals comprising data and information, including video data and information, from the second onboard transceiver 132 of the unmanned vehicle.

In one aspect, onboard camera system 130 transfers data and information, including video data and information, to second onboard transceiver 132 for wireless transmission of the data and information via wireless signals to base control system 120, including base controller 400, via second base transceiver 136. Second base transceiver 136 receives wireless signals comprising data and information, including video data and information, for transfer to base controller 400. Second base transceiver 136 extracts data and information, including video data and information, after reception of wireless signals comprising data and information, and transfers the data and information, including video data and information, to base controller 400 for viewing of the video data and information on monitoring device 430.

Thus, in one aspect, base controller 400 receives transmitted data and information, including video data and information, from one or more cameras 310. In one aspect, video data and information includes digital video data and information. As previously described, the one or more cameras 310 include one or more cameras 310a, 310b, 310c, 310n positioned on the unmanned vehicle. The one or more cameras 310 capture images, including video images, and provide these images, including video images, to second onboard controller 300 for transfer to base control system 120 via second onboard transceiver 132 and second base transceiver 136. In one aspect, cameras 310 may include analog and/or digital types of cameras.

As shown in FIG. 4B, sixth power supply 422 may provide second base transceiver 136 with voltage and/or power. However, in one aspect, voltage and/or power may be supplied to second base transceiver 136 by base control system 120 or fifth power supply 420. In one example, fifth power supply 420 supplies voltage and/or power to base control system 120, and base control system 120 then supplies voltage and/or power to second base transceiver 136. Alternately, fifth power supply 420 supplies voltage and/or power directly to second base transceiver 132.

In one embodiment, second base transceiver 136 comprises a Linksys 2.4 GHz Wireless-G Broadband Router manufactured by Linksys. The Linksys 2.4 GHz Wireless-G Broadband Router provides compatible serial communications with the Linksys 2.4 GHz Wireless-G Internet Video Camera of onboard camera system 130 of FIG. 3A. The Linksys 2.4 GHz Wireless-G Broadband Router includes wireless access point functionality to connect Wireless-G devices, such as the Linksys 2.4 GHz Wireless-G Internet Video Camera (onboard camera system 130) positioned on the unmanned vehicle, to a wireless network. The Linksys 2.4 GHz Wireless-G Broadband Router includes integrated 4-port full-duplex 10/100 Ethernet switch for connecting wired Ethernet computing devices that allows the laptop computer (base control system 120) to communicate with the Linksys 2.4 GHz Wireless-G Broadband Router via hardwired connection. Moreover, the Linksys 2.4 GHz Wireless-G Broadband Router includes Internet communication functionality that that allows the laptop computer base control system 120) to communicate with an Internet connection, such as a high-speed wireless LAN connection, to share digital color video images captured by the Linksys 2.4 GHz Wireless-G Internet Video Camera (onboard camera system 130). The Linksys 2.4 GHz Wireless-G Broadband Router can encode wireless serial transmissions using 128-bit WEP encryption for security.

A Linksys high gain antenna for the Linksys 2.4 GHz Wireless-G Broadband Router can be utilized to increase the effective strength of the transmitted serial signals and the sensitivity for the received signals. This high gain antenna improves communication reliability and reduces reception errors caused by weak signals.

In the present teachings the Ethernet port of the laptop computer of the land base control system is hardwired to the Linksys 2.4 GHz Wireless-G Broadband Router so as to communicate therewith and access the captured color video images from the Linksys Wireless-G Internet Video Camera. In general, Ethernet is a local area network technology that provides close proximity communication connections between computing devices. When networking at least two computing devices, a Ethernet communication protocol governs communications between the devices via an Ethernet cable. However, it should be appreciated that he laptop computer may utilize a wireless LAN transceiver to communicate with the Linksys 2.4 GHz Wireless-G Broadband Router without departing from the scope of the present invention.

FIG. 4C is a block diagram of another embodiment of onboard camera system 130 of FIG. 1D, and FIG. 4C is an exemplary embodiment of onboard camera system 130 of FIG. 4B.

As shown in FIG. 4C, base control system 120 includes first and second base transceivers 122, 136 connected to base controller 400. In one aspect, first base transceiver 122 is connected to base control system 120 via third communication interface 450. In another aspect, first base transceiver 122 can be directly connected to base control system 120 without departing from the scope of the present invention.

In one embodiment, base control system 120, including base controller 400 transfers data and information, including digital control data and information, to first base transceiver 122 via third and fourth communication interfaces 450, 452. First base transceiver 122 transmits and receives data and information, including digital control data and information, to and from base controller 400. First base transceiver 122 also transmits and receives data and information, including digital control data and information, to and from first onboard transceiver 112 via wireless signals. Therefore, data and information, including digital data and information, can be wirelessly transferred between base controller 400 and first onboard controller 200 via communication between first base transceiver 122 and first onboard transceiver 112. In various configurations, as described above, first, second, third, and fourth communication interfaces 250, 252, 450, 452 can be used along with first base transceiver 122 and first onboard transceiver 112 to provide a communication link between base controller 400 and first onboard controller 200.

In one embodiment, a user inputs a command to user input device 432, and user input device 432 transfers the user input command to base controller 400. Base controller 400 receives the input command from user input device 432, interprets the user input command as a servo control command, and transfers digital control data to base transceiver 122 via fourth and third communication interface 452, 450. First base transceiver 122 receives the digital control data from base controller 400, generates a wireless signal comprising the digital control data, and transmits the wireless signal comprising the digital control data to first onboard transceiver 112. First onboard transceiver 112 receives the wireless signal from first base transceiver 122, extracts the digital control data from the received wireless signal, and transfers the digital control data to first onboard controller 200. First onboard controller 200 receives the digital control data from the first onboard transceiver 112, interprets the digital control data as servo control data, generates servo control signals from the servo control data, and provides the generated servo control signals to servos 210 for control of servos 210 and the unmanned vehicle.

Alternately, first onboard controller 200 receives the digital control data from the first onboard transceiver 112, interprets the digital control data as servo control data, and transfers the servo control data to onboard servo controller 230. Onboard servo controller 230 receives the servo control data, generates servo control signals from the servo control data, and provides the generated servo control signals to servos 210 for control of servos 210 and the unmanned vehicle.

In one aspect, base controller 400 can communicate with first onboard controller 200 via first base transceiver 122 and first onboard transceiver 112 to transfer data and information therebetween.

In one embodiment, second onboard transceiver 132 of onboard control system 110 transmits video data and information, including digital video data and information, to second base transceiver 136 of base control system 120. Second base transceiver 136 receives the video data and information, including digital video data and information, from the second onboard transceiver 132, and transfers the received video data and information, including digital video data and information, to base controller 400 via fifth communication interface 454. Base controller 400 receives the video data and information, including digital video data and information, from the second base transceiver 136 and processes the video data and information, including digital video data and information, for viewing of captured analog and/or digital video and images on monitoring device 430.

In one embodiment, fifth communication interface 454 is connected and adapted to communicate with base controller 400 and second base transceiver 136 and comprises, for example, at least one of an Ethernet port, parallel port, serial port, USB port, etc.

In one aspect, base controller 400 can communicate with second onboard controller 300 via second base transceiver 136 and second onboard transceiver 132 to transfer data and information therebetween.

In one embodiment, base controller 400 is internally connected to fourth communication interface 452 for transfer of digital data and information therebetween via an internal data path. Input and output data port 466 of fourth communication interface 452 is connected to input and output data port 464 of third communication interface 450 for transfer of digital data and information therebetween via data path 482. Input and output data port 462 of third communication interface 450 is connected to input and output data port 460 of first base transceiver 122 for transfer of digital data and information therebetween via data path 480.

In one embodiment, base controller 400 is internally connected to fifth communication interface 454 for transfer of digital data and information therebetween via an internal data path. Input and output data port 470 of fifth communication interface 454 is connected to input and output data port 484 of second base transceiver 136 for transfer of digital data and information therebetween via data path 484.

As shown in FIG. 4C, base control system 120 further comprises one or more power supplies, such as fifth and sixth power supplies 420, 422, that provide power to base control system 120 including base system components 400, 430, 432, 452, 454, first base transceiver 122, third communication interface 450, and second base transceiver 136. In one aspect, voltage and/or power may be supplied to base control system 120 including base system components 400, 430, 432, 452, 454 by fifth power supply 420, and voltage and/or power may be supplied to first base transceiver 122, third communication interface 450, and second base transceiver 136 by sixth power supply 422. In one example, fifth power supply 420 supplies voltage and/or power to base control system 120, and base control system 120 then supplies voltage and/or power to first base transceiver 122, third communication interface 450, and second base transceiver 136. Alternately, fifth power supply 420 supplies voltage and/or power directly to first base transceiver 122, third communication interface 450, and second base transceiver 136.

It should be appreciated by those skilled in the art that the configuration of base control system 120 of the present invention may vary according to the various embodiments described herein without departing from the scope of the present invention.

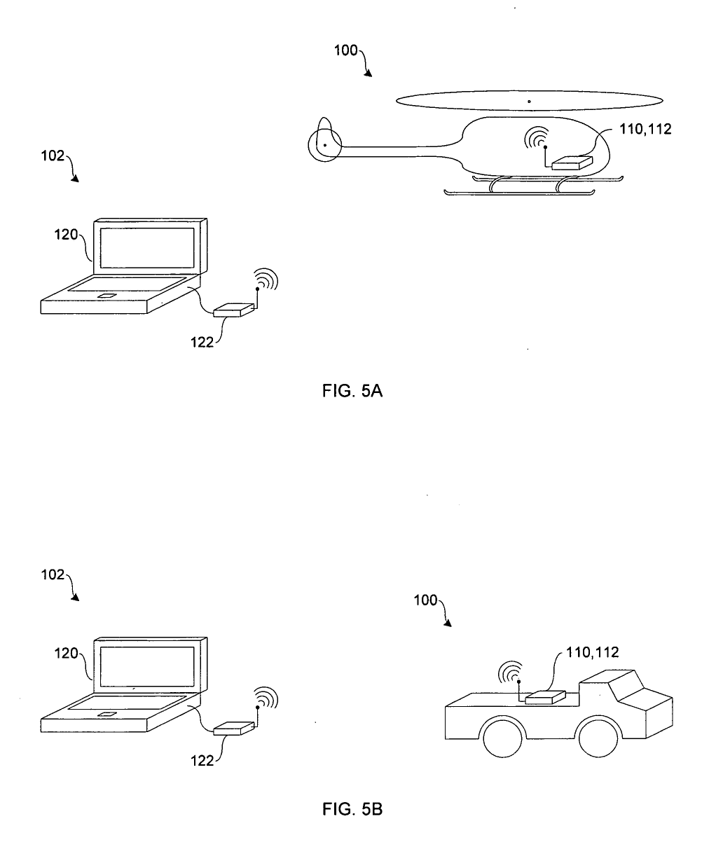

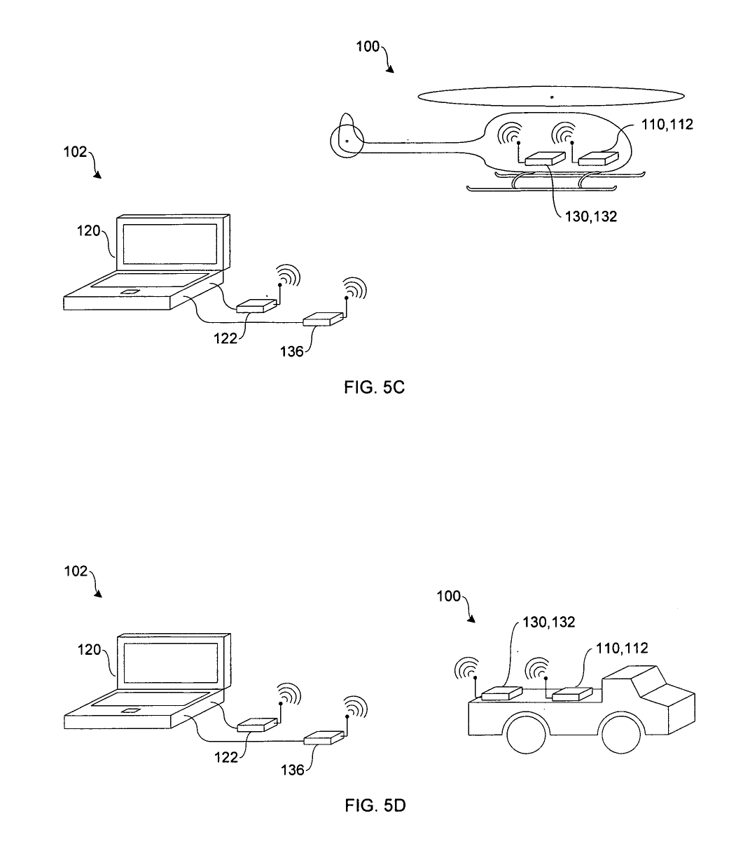

FIGS. 5A-5D are diagrams of various embodiments of onboard control system 110 and base control system 120 for the unmanned vehicle 100. In one aspect, FIGS. 5A-5B are diagrams that correspond to FIGS. 1A-1B, respectively, and FIGS. 5C-5D are diagrams that correspond to FIGS. 1C-1D, respectively.

In one embodiment, the unmanned vehicle 100 may comprise an unmanned aerial vehicle (UAV), such as for example, a helicopter, as shown in FIGS. 5A and 5C, or an airplane. In another embodiment, the unmanned vehicle 100 may also include an unmanned land or water based vehicle, such as, for example, a ground vehicle including and automobile, as shown in FIGS. 5B and 5D, a car, truck, semi-truck or bus, a train, including a subway train or light rail train, and a water vehicle, including a boat, ship or sailing vessel.

In one embodiment, the control system for the unmanned vehicles 100 of FIGS. 5A-5D includes onboard control system 110 and base control system 120. Base controller 400 of base control system 120 receives user input commands from user input device 432 and generates digital control data. First base transceiver 122 of base control system 120 is connected to base controller 400 and receives the digital control data from base controller 400. First base transceiver 122 transmits a plurality of wireless control signals comprising the digital control data. First onboard transceiver 112 of onboard control system 110 receives the plurality of wireless control signals from first base transceiver 122 and extracts the digital control data therefrom. First onboard controller 200 of onboard control system 110 is connected to first onboard transceiver 112 and one or more servos 210. First onboard controller 200 receives the digital control data from first onboard transceiver 112 and interprets the digital control data as servo control data to provide servo control signals to servos 210 to thereby control the unmanned vehicles 100 of FIGS. 5A-5D.

Alternately, in one embodiment, onboard control system 110 of the unmanned vehicle 100 includes onboard servo controller 230 connected between first onboard controller 200 and servos 210. Onboard servo controller 230 receives digital control data from first onboard controller 200 and interprets the digital control data as servo control data to provide servo control signals to servos 210 to thereby control servos 210 and the unmanned vehicles 100 of FIGS. 5A-5D.

In one embodiment, the control system for the unmanned vehicles 100 of FIGS. 5C-5D include a camera system 130 that is mounted to the unmanned vehicle 100 and transmits video signals to first onboard controller 400 via second onboard transceiver 132 and second base transceiver 136. In one aspect, camera system 130 comprises a digital video camera system that transmits digital video data to first onboard controller 200 via wireless signals. In another aspect, camera system 130 comprises a digital audio and video (AV) camera system that transmits digital audio and video data to first onboard controller 200 via wireless signals.

In one embodiment, it should be appreciated that data and information, including digital data and information, can be transferred between onboard control system 110 and base controller system 120 via an external relay means, such as for example, a communication tower, a communication satellite, etc., without departing from the scope of the present invention.

The control system of the present invention affords numerous control features and programmable options for onboard control system 110 of the unmanned vehicle via base control system 120, such as a personal computer (PC), a laptop computer, a tablet computer, and a personal digital assistant (PDA), through various communication systems, devices, and ports, such as, for example, an Ethernet, parallel, serial, USB, SCSI, PCI, LAN, wireless LAN, and broadband. In one aspect, the onboard control system of the unmanned vehicle is configured to communicate with the base control system so that wireless control signals are transmittable between these systems.

In one embodiment, since the present invention provides for programmed digital control of the unmanned vehicle, the control system of the present invention may include programmed flight routines, whether user activated or autonomous, of the unmanned aerial vehicle, such as a helicopter or airplane, that would utilize onboard sensors 240 to fly a predetermined or predefined flight path. In one aspect, a program stored in onboard control system 110 and/or base control system 120 may be modified to include programmed flight paths, flight routines, flight maneuvers, etc., including autonomous flying, hovering, turns, acrobatics, etc. Moreover, a user may be allowed to interrupt the autonomous flying at a predetermined point or time during execution to control the unmanned vehicle from base control system 120.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A control system for an unmanned vehicle comprising:
a plurality of servos;
a transceiver that receives a plurality of first control signals; and
a controller connected to the transceiver and the plurality of servos, wherein the controller receives the first control signals from the transceiver and processes the first control signals to provide a plurality of second control signals to the servos to thereby control the unmanned vehicle.

2. The system of claim 1, wherein the unmanned vehicle comprises an unmanned aerial vehicle.

3. The system of claim 2, wherein the unmanned aerial vehicle includes an airplane or a helicopter.

4. The system of claim 1, wherein the transceiver comprises a wireless transceiver that transmits and receives the first control signals.

5. The system of claim 1, wherein the first control signals comprise wireless signals and digital control data.

6. The system of claim 1, wherein the transceiver comprises a radio frequency (RF) transceiver that transmits and receives the first control signals.

7. The system of claim 1, wherein the first control signals comprise wireless radio frequency (RF) signals, and wherein the wireless radio frequency (RF) signals comprise digital control data.

8. The system of claim 1, wherein the controller comprises a microprocessor, microcontroller, or microcomputer.

9. The system of claim 1, wherein the controller interprets the first control signals as position control signals for position control of the servos.

10. The system of claim 1, wherein the controller provides the second control signals as position control signals to control the position of the servos.

11. The system of claim 1, wherein the control system comprises an onboard control system that is mounted to the unmanned vehicle.

12. The system of claim 1, wherein the control system further comprises a camera system that is mounted to the unmanned vehicle and transmits video signals.

13. The system of claim 12, wherein the camera system comprises a digital video camera system that transmits digital video data via wireless signals.

14. The system of claim 12, wherein the camera system comprises a digital audio and video (AV) camera system that transmits digital audio and video data via wireless signals.

15. The system of claim 1, wherein the control system further comprises at least one power supply that provides power to the transceiver, the plurality of servos, and the controller.

16. The system of claim 1, wherein the control system further comprises a sensor cluster connected to the controller, the sensor cluster comprising at least one positional and navigational sensor including at least one of a speed sensor, an altimeter sensor, a compass sensor, a pitch sensor, a roll sensor, a yaw sensor, a gps sensor, a position sensor, a direction sensor, and a turning direction sensor.

17. The system of claim 16, wherein the controller transmits sensor data and information related to the at least one positional and navigational sensor via the transceiver.

18. A control system for an unmanned vehicle comprising:
a plurality of servos;
a wireless transceiver that receives digital data via a plurality of wireless signals; and
a controller connected to the wireless transceiver and the plurality of servos, wherein the controller receives the digital data from the wireless transceiver, interprets the digital data as servo control data, and generates servo control signals to provide to the servos to thereby control the unmanned vehicle.

19. A control system for an unmanned vehicle having a plurality of servos, the system comprising:
a first controller that generates digital control data;
a first transceiver connected to the first controller so as to receive the digital control data from the first controller, the first transceiver transmits a plurality of wireless control signals comprising the digital control data;
a second transceiver that receives the plurality of wireless control signals from the first transceiver and extracts the digital control data therefrom; and
a second controller connected to the second transceiver and the plurality of servos, wherein the second controller receives the digital control data from the second transceiver and interprets the digital control data as servo control data to provide a plurality of servo control signals to the servos to thereby control the unmanned vehicle.

20. The system of claim 19, wherein the first controller generates the digital control data based, at least in part, on user input commands.

21. The system of claim 19, wherein the control system further comprises a servo controller connected between the second controller and the plurality of servos, and wherein the servo controller receives the digital control data from the second controller and interprets the digital control data as servo control data to provide the plurality of servo control signals to the servos to thereby control the unmanned vehicle.

22. The system of claim 19, wherein the servo controller interprets the servo control data as servo control signals for position control of the servos.

23. A control system for an unmanned aerial vehicle having a plurality of servos, the system comprising:
a base controller that generates digital control data;
a base wireless transceiver connected to the base controller so as to receive the digital control data from the base controller, the base wireless transceiver transmits a plurality of wireless control signals comprising the digital control data;
an onboard wireless transceiver positioned on the unmanned aerial vehicle that receives the plurality of wireless control signals from the base wireless transceiver and extracts the digital control data therefrom;
a first onboard controller positioned on the unmanned aerial vehicle and connected to the onboard wireless transceiver so as to receive the digital control data from the onboard wireless transceiver and process the digital control data to generate digital servo control data; and
a second onboard controller positioned on the unmanned aerial vehicle and connected to the first onboard controller and the plurality of servos, wherein the second onboard controller receives the digital servo control data from the first onboard controller and interprets the digital servo control data as servo position data to provide a plurality of servo control signals to the servos to thereby control the unmanned aerial vehicle.

24. The system of claim 23, wherein the second onboard controller comprises a servo controller that interprets the digital servo control data as servo position data to provide a plurality of servo position signals to the servos for position control of the servos.

25. The system of claim 23, wherein the control system further comprises an onboard camera system that is mounted to the unmanned aerial vehicle and transmits video signals to the base controller.

26. The system of claim 25, wherein the onboard camera system comprises a digital video camera system that transmits digital video data to the base controller via wireless signals.

27. The system of claim 25, wherein the onboard camera system comprises a digital audio and video (AV) camera system that transmits digital audio and video data to the base controller via wireless signals.

28. The system of claim 23, wherein the control system further comprises at least one base power supply that provides power to at least the base controller and the base wireless transceiver.

29. The system of claim 23, wherein the control system further comprises at least one onboard power supply mounted to the unmanned aerial vehicle that provides power to at least the onboard wireless transceiver, the first onboard controller, the second onboard controller, and the plurality of servos.

30. The system of claim 23, wherein the control system further comprises a sensor cluster connected to the first onboard controller, the sensor cluster comprising at least one positional and navigational sensor including at least one of a speed sensor, an altimeter sensor, a compass sensor, a pitch sensor, a roll sensor, a yaw sensor, a gps sensor, a position sensor, a direction sensor, and a turning direction sensor.

31. The system of claim 30, wherein the first onboard controller transmits digital data and information related to the at least one positional and navigational sensor to the base controller via wireless signals from the onboard wireless transceiver.

32. A method for controlling an unmanned vehicle having a plurality of servos, the method comprising:
receiving wireless signals comprising digital control data;
extracting the digital control data from the wireless signals;
interpreting the digital control data as servo control data;
generating servo control signals from the servo control data; and
providing the servo control signals to the servos to thereby control the unmanned vehicle.

33. The method of claim 32, further comprising generating digital control data.

34. The method of claim 33, further comprising transmitting wireless control signals comprising the digital control data.

35. The method of claim 32, wherein the unmanned vehicle comprises an unmanned aerial vehicle including an airplane or a helicopter.

36. The method of claim 32, wherein receiving wireless signals comprises receiving wireless radio frequency (RF) signals comprising the digital control data.

37. The method of claim 32, wherein interpreting the digital control data as servo control data comprises interpreting the digital control data as servo position data for position control of the servos.

38. The method of claim 32, wherein the method further comprises sensing positional and navigational orientation including sensing at least one of speed, altitude, compass direction, pitch, roll, yaw, geographical position, and turning direction.

39. The method of claim 32, wherein the method further comprises transmitting digital data and information related to sensing positional and navigational orientation via wireless signals.

40. The method of claim 32, wherein the method further comprises transmitting video signals from the unmanned vehicle.

41. The method of claim 32, wherein transmitting video signals comprises transmitting digital video data from the unmanned vehicle via wireless signals.

42. The method of claim 32, wherein transmitting video signals comprises transmitting digital audio and video (AV) data from the unmanned vehicle via wireless signals.
